(19) United States
(12) Patent Application Publication
(10) Pub. No.: US 2025/0266859 A1
(43) Pub. Date: Aug. 21, 2025

(54) TRIGGER FRAME FOR DYNAMIC SUB-BAND OPERATION

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Bilal Sadiq, Plano, TX (US); Rubayet Shafin, Allen, TX (US); Peshal Nayak, Plano, TX (US); Yue Qi, Plano, TX (US); Shunyao Wu, Allen, TX (US); Wei Sun, Allen, TX (US)

(21) Appl. No.: 19/022,035

(22) Filed: Jan. 15, 2025

Related U.S. Application Data
(63) Continuation of application No. 19/006,080, filed on Dec. 30, 2024.
(60) Provisional application No. 63/554,676, filed on Feb. 16, 2024.
(60) Provisional application No. 63/564,328, filed on Mar. 12, 2024.
(60) Provisional application No. 63/712,840, filed on Oct. 28, 2024.
(60) Provisional application No. 63/619,203, filed on Jan. 9, 2024.

(51) Int. Cl. H04B 1/66; H04L 1/00

(52) U.S. Cl. CPC H04B 1/667; H04L 1/0061

(57) ABSTRACT

An embodiment includes generating, by an access point (AP), a trigger frame that solicits a response from one or more stations (STAs), where the trigger frame includes a pre frame check sequence (pre-FCS) field, a padding field, and a frame check sequence (FCS) field, the pre-FCS field preceding the padding field, transmitting, to the one or more STAs, the trigger frame to request the one or more STAs to perform a dynamic sub-band switch operation, and determining whether the dynamic sub-band switch operation is successfully performed at the one or more STAs based on whether or not a response is received from the one or more STAs in response to the trigger frame.

### CROSS-REFERENCE TO RELATED APPLICATION(S)

This application is a continuation of U.S. patent application Ser. No. 19/006,080, entitled “TRIGGER FRAME FOR DYNAMIC SUB-BAND OPERATION” filed Dec. 30, 2024, which claims the benefit of priority from U.S. Provisional Application No. 63/619,203, entitled “USING TRIGGER FRAME FOR DYNAMIC SUB-BAND OPERATION” filed Jan. 9, 2024; U.S. Provisional Application No. 63/554,676, entitled “USING TRIGGER FRAME FOR DYNAMIC SUB-BAND OPERATION” filed Feb. 16, 2024; U.S. Provisional Application No. 63/564,328, entitled “USING TRIGGER FRAME FOR DYNAMIC SUB-BAND OPERATION” filed Mar. 12, 2024; and U.S. Provisional Application No. 63/712,840, entitled “USING TRIGGER FRAME FOR DYNAMIC SUB-BAND OPERATION” filed Oct. 28, 2024, all of which are incorporated herein by reference in their entireties.

### TECHNICAL FIELD

This disclosure relates generally to a wireless communication system, and more particularly to, for example, but not limited to, a trigger frame for dynamic sub-band operations.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network, comprising a memory; and a processor coupled to the memory. The processor is configured to generate a trigger frame that solicits a response from one or more stations (STAs), wherein the trigger frame includes a pre frame check sequence (pre-FCS) field, a padding field, and a frame check sequence (FCS) field, the pre-FCS field preceding the padding field; transmit, to the one or more STAs, the trigger frame to request the one or more STAs to perform a dynamic sub-band switch operation. The processor is configured to determine whether the dynamic sub-band switch operation is successfully performed at the one or more STAs based on whether or not a response is received from the one or more STAs in response to the trigger frame.

In some embodiments, the dynamic sub-band switch operation is a channel switch or a bandwidth switch operation, wherein the trigger frame is transmitted to one or more STAS operating in dynamic sub-band operation, enhanced multi-link single radio operation or dynamic power save operation modes.

In some embodiments, a value of the pre-FCS field is computed based on bits preceding a location of the pre-FCS field in the trigger frame.

In some embodiments, the trigger frame includes a user info list field including one or more user info fields and a location of the pre-FCS field in the trigger frame is determined based on the location of the user info fields addressed to the STAs that are expected to perform the dynamic sub-band switch operation, user info fields addressed to other STAs, and a start of the padding field.

In some embodiments, the trigger frame includes a user info list field that includes one or more user info fields, wherein bits of a pre-FCS value are carried across one or more adjacent user info fields with predetermined values for an association identifier (AID) subfields.

In some embodiments, the trigger frame includes a pre-FCS location field that indicates a location of the pre-FCS field within the trigger frame.

In some embodiments, the trigger frame is a multi-user request-to-send (MU-RTS) frame, wherein the processor is further configured to transmit a padding field of the MU-RTS frame on a wireless medium to protect the wireless medium during the dynamic sub-band switch operation.

In some embodiments, the pre-FCS field includes a pre-FCS termination field that includes a pre-determined bit sequence which indicates a start of the padding field.

One aspect of the present disclosure provides a station (STA) in a wireless network, comprising: a memory; and a processor coupled to the memory. The processor is configured to receive, from an access point (AP), a trigger frame that includes a pre frame check sequence (pre-FCS) field, a padding field, and a frame check sequence (FCS) field, the pre-FCS field preceding the padding field. The processor is configured to transmit, to the AP, a response frame in response to the trigger frame.

In some embodiments, the processor is further configured to determine a presence of the pre-FCS field based on a presence or location indication of the pre-FCS field carried in the trigger frame.

In some embodiments, the processor is further configured to perform a validity check of the pre-FCS field of the trigger frame.

In some embodiments, the validity check of the pre-FCS field includes computing an FCS value using a received bits of the trigger frame that precede the pre-FCS field, and comparing the computed FCS value to the pre-FCS field.

In some embodiments, the processor is further configured to receive an indication in the trigger frame that requests the STA perform a dynamic sub-band switch operation; and determine whether to comply with the request in the trigger frame based on the result of the validity check of the pre-FCS field.

In some embodiments, the processor is further configured to, based on the result of the validity check of the pre-FCS field, perform an early termination of the reception of the trigger frame.

One aspect of the present disclosure provides a computer-implemented method for wireless communication by an access point (AP) in a wireless network. The method comprises generating a trigger frame that solicits a response from one or more stations (STAs), wherein the trigger frame includes a pre frame check sequence (pre-FCS) field, a padding field, and a frame check sequence (FCS) field, the pre-FCS field preceding the padding field. The method comprises transmitting, to the one or more STAs, the trigger frame to request the one or more STAs to perform a dynamic sub-band switch operation. The method comprises determining whether the dynamic sub-band switch operation is successfully performed at the one or more STAs based on whether or not a response is received from the one or more STAs in response to the trigger frame.

In some embodiments, the dynamic sub-band switch operation is a channel switch or a bandwidth switch operation, wherein the trigger frame is transmitted to one or more STAs operating in dynamic sub-band operation, enhanced multi-link single radio operation or dynamic power save operation modes.

In some embodiments, a value of the pre-FCS field is computed based on bits preceding a location of the pre-FCS field in the trigger frame.

In some embodiments, the trigger frame includes a user info list field including one or more user info fields and a location of the pre-FCS field in the trigger frame is determined based on a location of the user info fields addressed to the STAs that are expected to perform the dynamic sub-band switch operation, user info fields addressed to other STAs, and a start of the padding field.

In some embodiments, the trigger frame includes a user info list field that includes one or more user info fields, wherein bits of a pre-FCS value are carried across one or more adjacent user info fields with predetermined values for an association identifier (AID) subfields.

In some embodiments, the trigger frame includes a pre-FCS location field that indicates a location of the pre-FCS field within the trigger frame.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an Extremely High Throughput (EHT) Operation element transmitted by an AP in accordance with an embodiment.

FIG. 5 illustrates a Very High Throughput (VHT) Capabilities element in accordance with an embodiment.

FIG. 6 illustrates a Multi-User Request-To-Send (MU-RTS) trigger frame format in accordance with an embodiment.

FIG. 7 illustrates a Buffer Status Report Poll (BSRP) Trigger frame format in accordance with an embodiment.

FIG. 8 illustrates an example of wasted Basic Service Set (BSS) bandwidth in accordance with an embodiment.

FIG. 9 illustrates dynamic Sub-Band operation (DSO) switch operation in accordance with an embodiment.

FIG. 10A illustrates an operating procedure for enhanced Multi-link Single-radio operation (EMLSR) links in accordance with an embodiment.

FIG. 10B illustrates an operating procedure for a non-AP MLD in enhanced multi-link multi-radio (EMLMR) mode in accordance with an embodiment.

FIG. 11 illustrates an example of serving DSO devices on a secondary channel and non-DSO STAs on a primary channel in accordance with an embodiment.

FIG. 12A illustrates a Common Info field of the MU-RTS frame as an sub-band switch (SBS) initial control (IC) in accordance with an embodiment.

FIG. 12B illustrates an example of a Common Info field of the MU-RTS frame as an SBS IC in accordance with an embodiment

FIG. 13 illustrates a User Info field of the MU-RTS frame as an SBS IC in accordance with an embodiment.

FIG. 14A illustrates a Pre-frame check sequence (FCS) field at the end of the User Info List of the MU-RTS frame in accordance with an embodiment.

FIG. 14B illustrates a Pre-FCS field at the end of the User Info List with inclusion of a Pre-FCS Identifier subfield in accordance with an embodiment.

FIG. 14C illustrates a pre-FCS field as part of two special User Info fields of a MU-RTS frame in accordance with an embodiment.

FIG. 14D illustrates a pre-FCS field in a second of two special User Info fields of a MU-RTS frame in accordance with an embodiment.

FIG. 14E illustrates a short Pre-FCS field in one special User Info fields of MU-RTS frame in accordance with an embodiment.

FIG. 14F illustrates a special sequence indicating the termination of the pre-FCS field for STAs in accordance with an embodiment.

FIG. 15 illustrates a hidden node problem for dynamic sub-band operation (DSO) operation in accordance with an embodiment.

FIG. 16 illustrates a physical protocol data unit (PPDU) carrying an SBS IC frame in accordance with an embodiment.

FIG. 17A illustrates an example of indication of whether a DSO device can receive BSRP as SBS IC in the UHR Capabilities element in accordance with an embodiment.

FIG. 17B illustrates an example of indication of whether a DSO device can receive BSRP as SBS IC in the DSO Notification frame in accordance with an embodiment.

FIG. 18 illustrates an EML Control field as an optional subfield of the DSO Notification frame in accordance with an embodiment.

FIG. 19 illustrates a flow chart of an example process performed by an AP for transmitting a SBS IC frame to initiate a sub-band switch operation of DSO devices.

FIG. 20 illustrates a flow chart of an example process performed by a non-AP STA upon receiving an SBS IC frame and for the transmission of the corresponding response in accordance with an embodiment.

FIG. 21 illustrates a User Info field of the SBS IC in accordance with an embodiment.

FIG. 22 illustrates a User Info field of an SBS in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

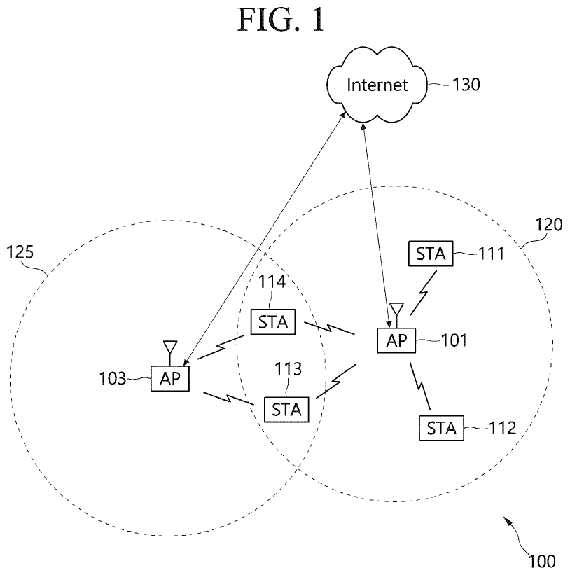

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

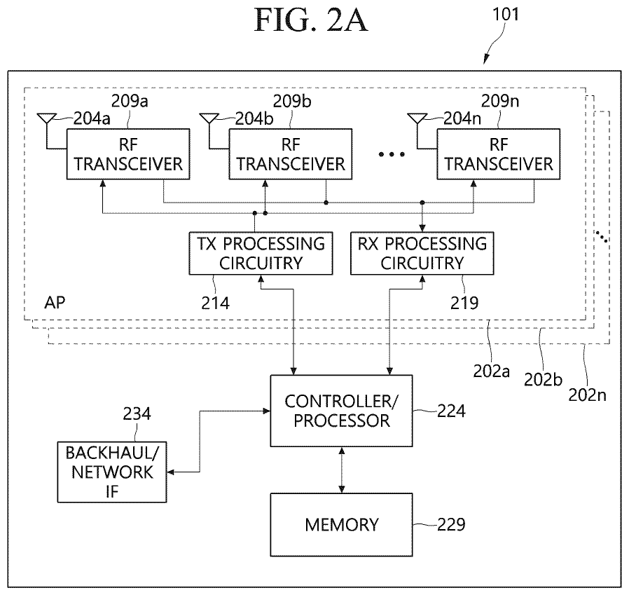

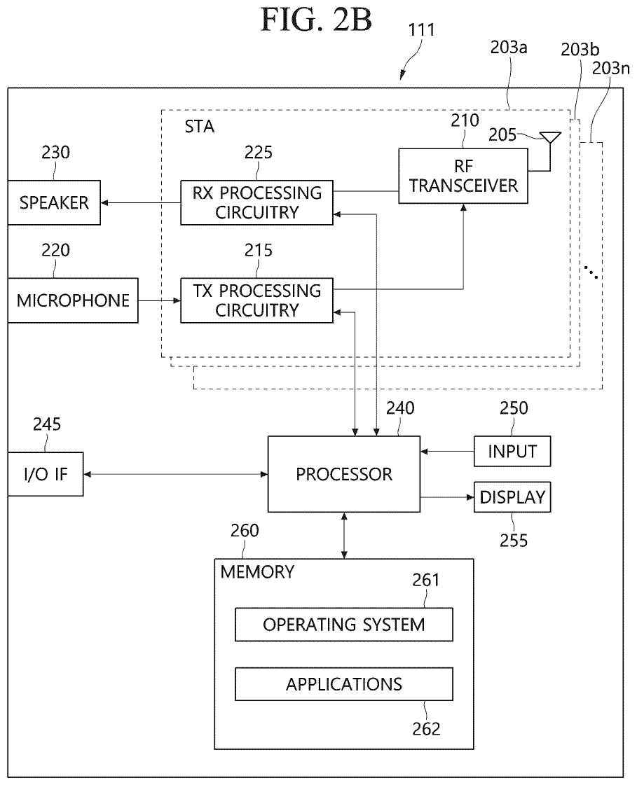

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

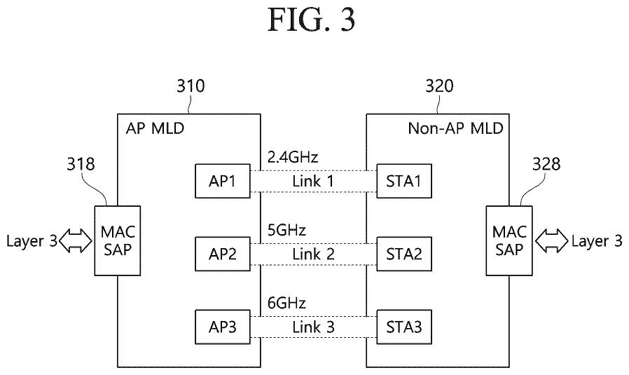

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: 1) IEEE 802.11-2020, “Wireless LAN Medium Access Control (MAC) and Physical Layer (PHY) Specifications;” 2) IEEE 802.11ax-2021, “Wireless LAN Medium Access Control (MAC) and Physical Layer (PHY) Specifications;” 3) IEEE P802.11be/D4.0, “Wireless LAN Medium Access Control (MAC) and Physical Layer (PHY) Specifications;”

Before the IEEE 802.11n standard (up to 802.11g), WiFi devices were allowed to use up to 20 MHz of operating bandwidth. Since the IEEE 802.11n, the concept of channel bonding was introduced to improve throughput, where a wireless device can opportunistically bond a non-primary channel along with a primary 20 MHz channel to transmit packets with a higher bandwidth. IEEE 802.11n considered bonding up to 40 MHz. IEEE 802.11ac expanded channel bonding up to 80 and 160 MHz. IEEE 802.11ax expanded channel bonding up to 160 MHz and introduced idea of puncturing. IEEE 802.11be introduced channel bonding up to 320 MHz and further developed the puncturing concept to more configurations. The benefits of channel bonding may be two-fold. In particular, if a neighbor BSS is idle, there is a clear benefit of increased throughput. If neighbor BSS has traffic, channel bonding can cause a neighbor BSS to be unable to access the channel by taking away its primary channel. Accordingly, channel bonding may improve transmission efficiency (and hence throughput), at the cost of increased latency.

With channel bonding, an Access Point (AP) can support one or more of the following maximum bandwidths (BW) of operation: X=20, 40, 80, 160 or 320 MHz among others. An AP may indicate its current operating channel's parameters using one or more Operation elements that the AP transmits. The operating elements may include of the Very High Throughput (VHT), High Efficiency (HE), or Extremely High Throughput (EHT) Operation elements.

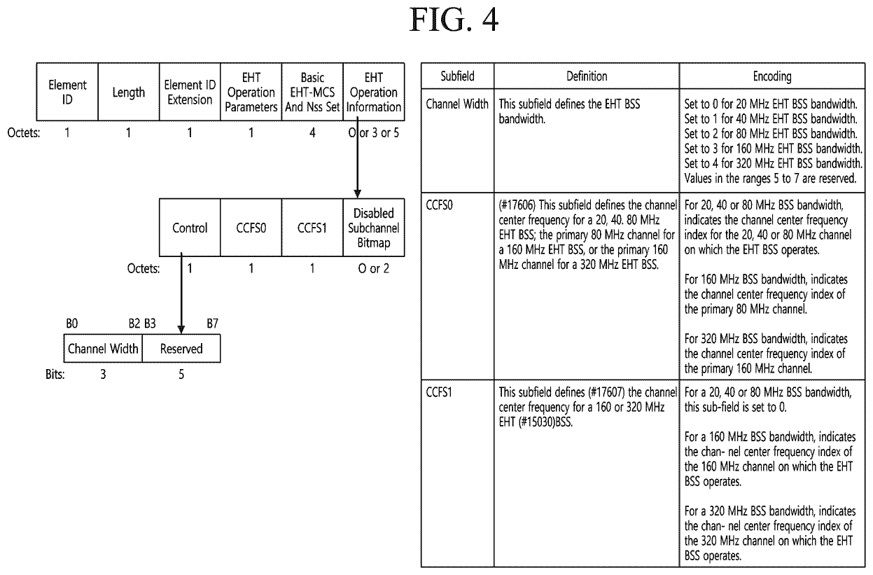

FIG. 4 illustrates an EHT Operation element transmitted by an AP in accordance with an embodiment. The EHT Operation element may include an Element ID field, a Length field, an Element ID Extension field, an EHT Operation Parameters field, a Basic EHT-MCS and Nss Set field, an EHT Operation Information field. The EHT Operation Information field may include a Control field, a CCFS0 field, a CCFS1 field, a Disabled Subchannel Bitmap field. The Control field may include a Channel Width field and a reserved field.

The Element ID field may provide an identifier of the element. The Length field may include length information of the element. The Element ID Extension field may include extension information for the element. The EHT Operation Parameters field may include operation parameters for the element. The Basic-EHT-MCS and Nss Set field may include MCS and Nss information for the element. The EHT Operation Information field may include operation information for the element.

The Control field may include control information for the element and can include the Channel Width field and a Reserved field. The Channel Width field may provide channel width information and may define the EHT BSS bandwidth. The Reserved field may be reserved.

The CCFS0 field may define the channel center frequency for a 20, 40, 80 MHz EHT BSS, the primary 80 MHz channel for a 160 MHz EHT BSS, or the primary 160 MHz channel for a 320 MHz EHT BSS. The CCFS1 field may define the channel center frequency for a 160 or 320 MHz EHT BSS. The Disabled Subchannel Bitmap may provide bitmap information for the disabled subchannels. An AP may include these Operating elements in Beacons and/or Probe response frames, and these elements may include: (i) Channel Width subfield to indicate the maximum BSS bandwidth X, (ii) Channel Center Frequency Segment (CCFS) 0 field to indicate the center frequency of the primary X/2 MHz channel for the BSS and (iii) CCFS 1 field to indicate the center frequency of the X MHz channel.

Although the Operation element indicates the maximum supported bandwidth of the AP, the AP may also support STAs with smaller operating bandwidths. In fact, due to power consumption and cost reasons, a station (STA) may often support a smaller bandwidth than an AP. An EHT AP/STA may declare the channel widths at which it is capable of operating on in the PHY Capabilities Information field of the HT/VHT/HE/EHT Capabilities elements that it transmits in Beacon and Probe response frames.

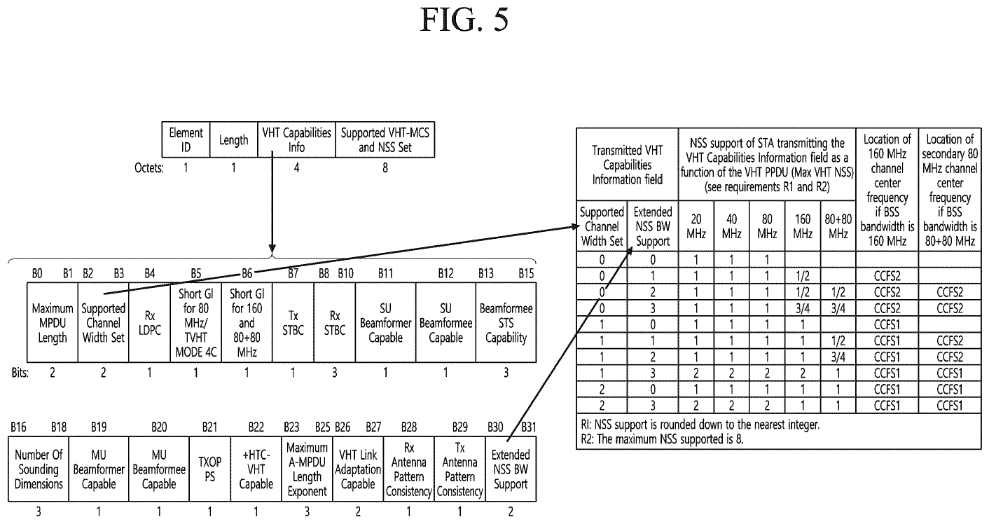

FIG. 5 illustrates a VHT Capabilities element in accordance with an embodiment. The number of spatial streams (NSS) that can be supported at all BWs is indicated in the Supported MCS and NSS Set field. NSS Supported for each BW is identified from the ‘Supported Channel Width Set’+ ‘Extended NSS BW Support’ fields. When serving a STA that has a smaller bandwidth of X MHz than the AP, the AP does not allocate a Resource Unit (RU) outside of the primary X MHz in a HE MU PPDU or HE TB PPDU to the STA if the non-AP STA has not set up Subchannel Specific Transmission (SST).

In particular, the VHT Capabilities element may include an Element ID field, a Length field, a VHT Capabilities Info field, and a Supported VHT-MCS and NSS Set field. The Element ID field may provide an identifier of the element. The Length field may provide length information for the element. The VHT Capabilities Info field may provide capabilities information for the element and can include several subfields as described below. The Supported VHT-MCS and NSS Set field may provide information on the NSS that can be supported at all BWs.

The VHT Capabilities Info field can include several subfields, including a Maximum MPDU Length field, a Supported Channel Width Set field, a RX LDPC field, a Short G1 for 160 and 80+80 MHz field, a Tx STBC field, a Rx STBC field, a SU Beamformer Capable field, a SU Beamformee Capable field, a Beamformee STA Capability field, a Number of Sounding Dimensions field, a MU Beamformer Capable field, an MU Beamformee Capable field, a TXOP PS field, a +HTC-VHT Capable field, a Maximum A-MPDU Length Exponent field, a VHT Link Adaptation Capable field, a Rx Antenna Pattern Consistency field, a Tx Antenna Patter Consistency field, a Tx Antenna Patter Consistency field, and an Extended NSS BW Support field.

The Maximum MPDU Length field may provide information regarding a maximum length of the MPDU. The Supported Channel Width Set field may provide supported channel width set information.

The Rx LDPC field provides information regarding a receiver low-density parity-check (LDPC) and may be set to 1 if the transmitter can receive LDPC-encoded frame.

The Short GI for 80 MHz/TVHT Mode 4C field provides information on a short guard interval and may be set to 1 if the transmitter can receive frames transmitted using the short guard interval with the indicated channel bandwidth.

The Short GI for 160 and 80+80 MHz field may provide information on a short guard interval and may be set to 1 if the transmitter can receive frames transmitted using the short guard interval with the indicated channel bandwidth.

The Tx STBC field may be set to 1 to indicate that transmission of STBC-coded frames is supported.

The Rx STBC field may describe how many spatial streams are supported for reception of STBC-coded frames. It may be set to 0, 1, 2, 3, or 4, describing the maximum number of spatial streams supported on reception. For support of one spatial stream, the field may take the value 1. The value 0 may be used to indicate that STBC is not supported, and the values 5-7 may be reserved

The single-user (SU) Beamformer Capable field, when set to 1, may indicate that the transmitter is capable of operating as a single-user beamformer that exchanges packets with one other station.

The SU Beamformee Capable field, when set to 1, may indicate that the transmitter is capable of operating as a single-user beamformee that exchanges packets with one other station.

The Beamformee STS Capability field may provide STA capability information on the beamformee.

The Number of Sounding Dimensions field may be used in the channel measurement process for beamforming to indicate the maximum number of antennas that can participate in channel measurement.

The MU Beamformer Capable field may provide information regarding capabilities of the MU Beamformer.

The MU Beamformee Capable field may provide information regarding capabilities of the MU Beamformee.

The TXOP PS field is a TXOP power save (PS) field, where an AP can set this bit to 1 to enable power save operations during a VHT transmission burst, or 0 to disable them. Stations associating with a network will set this bit to 1 to indicate the capability is enabled or 0 if it is disabled.

The +HTC-VHT Capable field may be set to 1 to indicate that the transmitter is capable of receiving the VHT-variant HT Control field.

The Maximum A-MPDU Length Exponent field can take on the values 0-7 and may be used to communicate the size of the A-MPDU that may be transmitted.

The VHT Link Adaption Capable field may be used for link adaptation feedback to select the most appropriate MCS for a link using explicit feedback.

The Rx Antenna Pattern Consistency field may be set to 1 if the antenna pattern of the transmitter does not change after association completes, and 0 otherwise.

The Tx Antenna Pattern Consistency field may be set to 1 if the antenna pattern of the transmitter does not change after association completes, and 0 otherwise.

The Extended NSS BW Support field may provide extended NSS BW support information.

To support trigger-based communication, in IEEE 802.11ax, several trigger frames have been proposed. Two prominent trigger frames are described below.

The multi-user request-to-send (MU-RTS) trigger frame was introduced to solicit a clear-to-send (CTS) response from at least one of multi-user capable STAs that are addressed by the MU-RTS frame. This may be beneficial for detecting hidden node situations for a multi-user transmission framework. The MU-RTS is transmitted as a broadcast frame, and usually in the legacy non-HT duplicate Physical Protocol Data Unit (PPDU) format so that all STAs are able to decode it. The MU-RTS-CTS procedure is used to prevent hidden node issues and for reserving the channel for MU transmissions. In each 20 MHz channel where Transmit opportunity (TXOP) is won, the AP sends a MU-RTS trigger and requests at least one non-AP STA should respond with a CTS on each such 20 MHz channel.

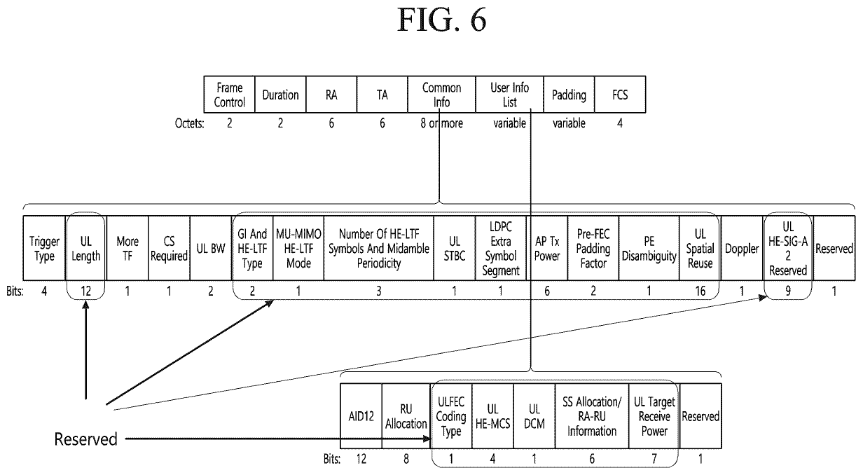

FIG. 6 illustrates a MU-RTS trigger frame format in accordance with an embodiment. As shown in FIG. 6, the MU-RTS has a Common Info field and a User Info field. The Common Info field indicates parameters that are common to all the addressed STAs, such as the bandwidth of the TXOP and how each STA should respond to the MU-RTS frame. The User Info field includes RU Allocation to one or more AIDs. Bits B0-B7 of RU Allocation indicate the location of the X MHz primary channel where the CTS should be sent. After successful reception of the CTSs, the AP may transmit a HE TB PPDU.

The UL BW field of Common Info field of MU-RTS indicates the BW of the TB PPDUs that follow. The AP waits for a CTSTimeout interval to see if a response is obtained, if no response is obtained the AP assumes the MU-RTS has failed and may initiate a PIFS recovery or may backoff. When a STA responds to an MU-RTS, it is expected to ensure that the transmission start time of the response frame is within ±0.4 μs+16 μs from the end, at the STA's transmit antenna connector, of the last OFDM symbol of the triggering PPDU (if it contains no PE field) or of the PE field of the triggering PPDU (if the PE field is present). The responding STA is also required to compensate for carrier frequency offset (CFO) error and symbol clock error with respect to the triggering PPDU when transmitting the response. The residual CFO after correction should be below 2 KHz for an MU-RTS frame.

In FIG. 6, the MU-RTS Trigger frame includes a Frame Control field, a Duration field, a Receiver Address (RA) field, a Transmitter Address (TA) field, a Common Info field, a User Info List field, a Padding field, and a FCS field.

The Frame Control field provides frame control information for the frame including version, type, subtype, among other information. The Duration field provides duration information. The RA field provides the address of the recipient STA. The TA field provides the address of the transmitting STA. The Common Info field provides parameters that are common to all the addressed STAs, and includes various subfields as described below. The User Info List field provide RU allocation to one or more AIDs, and include several subfields as described below.

The Common Info field may include a Trigger Type field, a UL Length field, a More TF field, a CS Required field, a UL BW field, a GI and HE-LTF Type field, a MU-MIMO HE-LTF Mode field, a Number of HE-LTF Symbols and Mid-Amble Periodicity field, a UL STBC field, a LDPC Extra Symbol Segment field, a AP TX Power field, a Pre-FEC Padding Factor field, a PE Disambiguity field, a UL Spatial Reuse field, a Doppler field, a UL HE-SIG-A 2 Reserved field, and a Reserved field.

The User Info List field may include a AID12 field, a RU Allocation field, a UL FEC Coding Type field, a UL HE-MCS field, a UL DCM field, a SS Allocation/RA-RU Information field, a UL Target Receive Power field, and a Reserved field.

The Trigger Type field may provide information regarding a type of the trigger frame. The UL Length field may provide length information. The More TF field may provide more trigger frame information. The CS Required field may enable/disable the CS required. It is set to On to indicate that the STAs identified in the Per User Info fields are required to use energy detection (ED) to sense the medium and to consider the medium state and the NAV in determining whether or not to respond. The CS Required subfield is set to Off to indicate that the STAs identified in the User Info fields are not required consider the medium state or the NAV in determining whether or not to respond.

The UL BW field sets the bandwidth of the PPDU. The GI and HE-LTF Type field sets the GI and LTF type of the PPDU. The MU-MIMO HE-LTF Mode field provides the LTF mode information. The Number of HE-LTF Symbols and Mid-Amble Periodicity field sets the number of LTF symbols present in the HE trigger-based PPDU response. The UL STBC field may enable/disable the STBS encoding of the HE trigger-based PPDU response. The LDPC Extra Symbol Segment field may enable/disable the LDPC extra symbol segment. It may be set to On when the LDPC extra symbol segment is present and set to Off otherwise. The AP TX Power field may set the combined average power per 20 MHz bandwidth of all transmit antennas used to transmit the trigger frame at the HE AP. Value 0 to 60 maps to −20 dBm to 40 dBm with 1 dB resolution. The Pre-FEC Padding Factor field may provide padding factor information. The PE Disambiguity field may provide disambiguity information. The UL Spatial Reuse field may set the value for the spatial reuse field in the HE-SIG-A field of the HE trigger-based PPDU transmitted as a response to the trigger frame. The Doppler field may indicate a high Doppler mode of transmission. The UL HE-SIG-A 2 Reserved field may set the value of the reserved bits in HE-SIG-A2 of the HE trigger-based PPDU transmitted as a response to the trigger frame. The Reserved field may be reserved. The User Info List field may include several subfields as described.

The AID12 field may set the least significant 12 bits of the AID of the STA for which the User Info field is intended. The RU Allocation field may set the RU allocation used by the HE trigger-based PPDU of the STA identified by the AID12 subfield. The UL FEC Coding Type field may set the code type of the HE trigger-based PPDU response of the STA identified by the AID12 subfield, 0 for BCC and 1 for LDPC. The UL HE-MCS field may set the MCS of the HE trigger-based PPDU response of the STA identified by the AID12 subfield. The UL DCM field may set the dual carrier modulation of the HE trigger-based PPDU response of the STA identified by the AID12 subfield. The SS Allocation/RA-RU Information field may set the spatial streams of the HE trigger-based PPDU response of the STA identified by the AID12 subfield, 3 bits for starting spatial stream, 3 bits for spatial stream number. The UL Target Receive Power field, may set the target received signal power of the HE trigger-based PPDU response of the STA identified by the AID12 subfield. The Reserved field may be reserved.

Subchannel specific transmission (SST) is an optional feature for the AP and non-AP STA introduced in IEEE 802.11-2020 standard, that allows a non-AP STA to negotiate operating on a specific band during a trigger enabled Target Wake Time (TWT) schedule. The TWT request/response may use the TWT Channel field to indicate the secondary channel requested to include the RU allocations addressed to the HE SST non-AP STA that is a X MHz operating STA. During the SP, the non-AP STA shall be available in the subchannel indicated in the TWT Channel field of the TWT response at TWT start times and does not access the medium in the subchannel using DCF or EDCAF, i.e., it can only be triggered by the AP. An HE SST non-AP STA may include a Channel Switch Timing element in (Re-)Association Request frames it transmits to an HE SST AP to indicate the time required by the STA to switch between different subchannels. The received channel switch time informs the HE SST AP of the duration of time that the HE SST non-AP STA might not be available to receive frames before the TWT start time and after the end of the trigger enabled TWT SP.

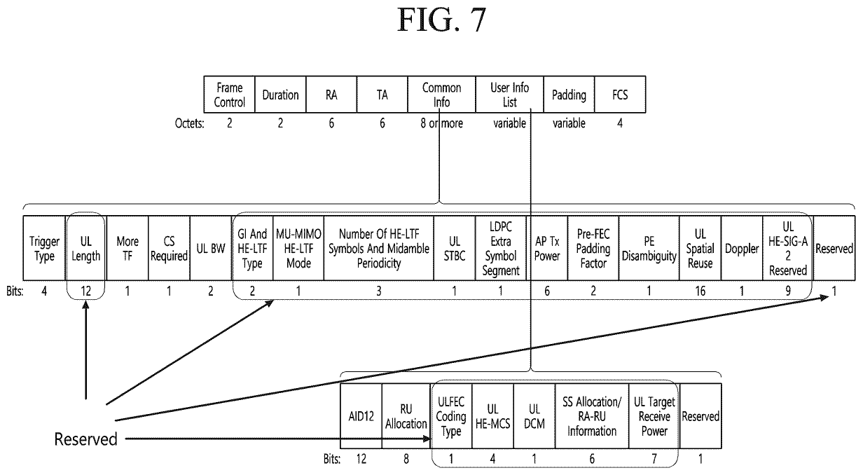

FIG. 7 illustrates a buffer status report poll (BSRP) Trigger frame format in accordance with an embodiment. The BSRP trigger frame was introduced to trigger an uplink response from one or more multi-user capable STAs that are addressed by the BSRP frame via OFDMA. The response may include the uplink Buffer Status Report corresponding to different traffic categories at the responding STA. This response may be useful for the triggering device to subsequently assign uplink resources for the responding STAs for their trigger-based uplink transmissions. Each STA addressed in the BSRP has a corresponding User Info field in the BSRP and the RU Allocation field of the User Info field indicates the set of resource units (RUs) on which the STA is expected to send the response frame. When a STA responds to a BSRP, it is expected to ensure that the transmission start time of the response frame is within ±0.4 μs+16 μs from the end, at the STA's transmit antenna connector, of the last OFDM symbol of the triggering PPDU (if it includes no PE field) or of the PE field of the triggering PPDU (if the PE field is present). The responding STA is also required to compensate for carrier frequency offset (CFO) error and symbol clock error with respect to the triggering PPDU when transmitting the response. The residual CFO after correction should be below 300 Hz for a BSRP frame.

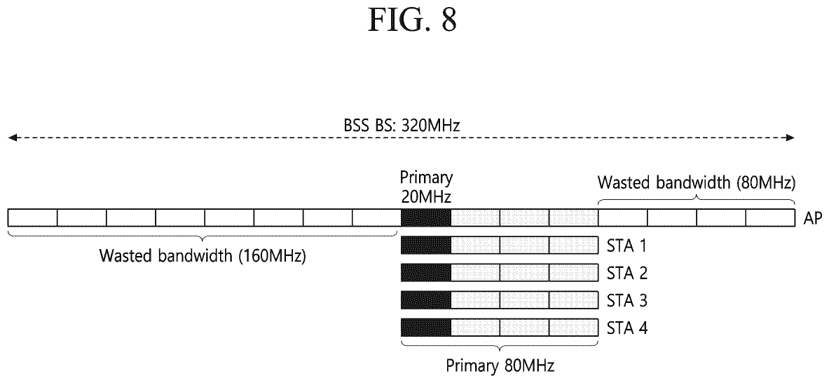

With newer WiFi generations, with the intent of increasing throughputs, the maximum supported bandwidths by the specifications have increased. For example, with the IEEE 802.11be, a maximum bandwidth of 320 MHz can be supported via channel bonding. However, a non-AP STA may often operate with a much smaller bandwidth, e.g., 80 MHz. This may be due to cost and power considerations, and also due to the fact that the 320 MHz bandwidth may not always be available due to transmissions by neighboring devices. This may reduce the efficiency of the AP since even if it is able to win the channel on 320 MHz it can't exploit it since all the 80 MHz STAs can be served on the primary 80 MHz channel as illustrated in FIG. 8.

In particular, FIG. 8 illustrates an example of wasted BSS bandwidth when all associated STAs support a narrow bandwidth in accordance with an embodiment. To enable an AP to exploit its full 320 MHz bandwidth (when it is able to win channel access for it) while allowing STAs to operate on a smaller bandwidth, the concept of Dynamic Sub-band Operation (DSO) has been proposed in the discussions for IEEE 802.11bn. In particular, the BSS BS supports 320 MHz bandwidth, however, each of STA1, STA2, STA3, STA4, and STA5 use only the same 80 MHz bandwidth. As indicated, the primary channel is 20 MHz, and each box represents 20 MHz of bandwidth. Accordingly, there are a remaining 160 MHz of wasted bandwidth and 80 MHz of wasted bandwidth outside of the utilized 80 MHz of bandwidth. A mechanism to resolve this issue may include where a non-AP MLD can perform Dynamic Sub-band Operation (DSO), wherein it can switch to a new subchannel that is outside of its initial operating bandwidth upon receiving a request from an AP.

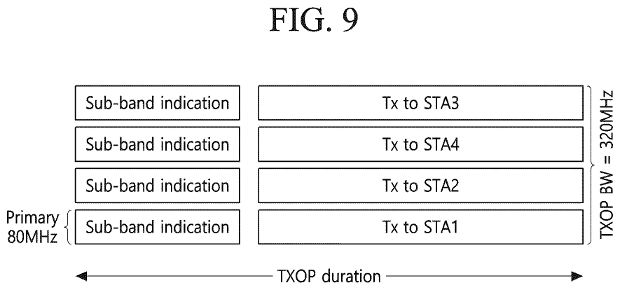

FIG. 9 illustrates DSO Sub-band switch operation in accordance with an embodiment. A DSO device is a limited bandwidth device, that can switch to a specific sub-band of the AP's operating channel on demand. Thus, when winning a TXOP for 320 MHz, an AP can indicate different DSO capable STAs to switch to different 80 MHz sub-bands that jointly occupy the entire 320 MHz in a sub-band switch initial control (SBS IC) frame. The AP initiates transmission to the DSO STAs on their specified sub-bands after sufficient delay to allow the DSO devices to perform the channel switch. The AP also ensures protection of the TXOP for the duration of this switch. At the end of the TXOP, the DSO STAs switch back to the primary channel.

More recently in the discussions for IEEE 802.11bn, several other features have also been discussed that involve a device changing its operating channel or bandwidth of operation on a frequent basis. Before introduction of non-primary channel access (NPCA), as per baseline operation, the AP or an associated non-AP STA can transmit on any non-primary channel within the BSS bandwidth if it also transmits on the primary 20 MHz channel. If the primary channel is busy due to OBSS TXOP, then no transmission is possible even if there is a secondary channel that is idle. This can increase the channel access delay and reduce the efficiency of channel utilization. As a solution to this, the mechanism of non-primary channel access (NPCA) has been proposed. When an AP enables NPCA operation, the AP may also disclose one or more back-up 20 MHz primary channels. If an OBSS transmission occupies the primary channel of the AP for a certain Network Allocation Vector (NAV) duration, the AP and associated non-AP STAs that support NPCA may switch to one of the back-up primary channels for performing frame exchanges, while treating that backup channel as the temporary primary channel till the end of the NAV duration on the main primary channel. During this time, the transmissions may still be limited to be within the BSS bandwidth. The AP and non-AP STAs may return to the primary channel by the end of this NAV duration.

Dynamic Power Save (DPS) operation has been proposed in order to save AP or non-AP STA power consumption, and yet minimize the degradation in performance for latency sensitive traffic. In DPS mode, by default the AP or non-AP STA may operate with reduced capabilities, e.g., one or more of reduced channel width, support for limited Physical Protocol Data Unit (PPDU) formats, a reduced MCS set and NSS set. The AP or non-AP STA may operate with reduced capabilities for reception, for transmission, or for both. Operating with reduced capabilities may enable the AP or non-AP STA to save power. However, upon receiving a request within a TXOP, the AP or non-AP STA can increase one or more of its supported bandwidth (BW), supported PPDU formats, MCS set and NSS set for at least the duration of the TXOP. Thus, after sending a request to the AP or non-AP STA to increase the capabilities of an AP or non-AP STA, the TXOP owner can perform communication at the enhanced channel width, PPDU formats, MCS and NSS values for the rest of the TXOP. After the end of the TXOP or after a predetermined amount of time from the end of the TXOP, the AP or non-AP STA may return to its reduced Operating Parameters. Peer STAs that do not support DPS may operate with the DPS AP or non-AP STA as per its reduced operating parameters, while peer STAs that support DPS may either operate with the DPS AP or non-AP STA as per its reduced operating parameters, or may operate at the AP or non-AP STA's enhanced operating parameters after sending a request to the AP or non-AP STA to transition.

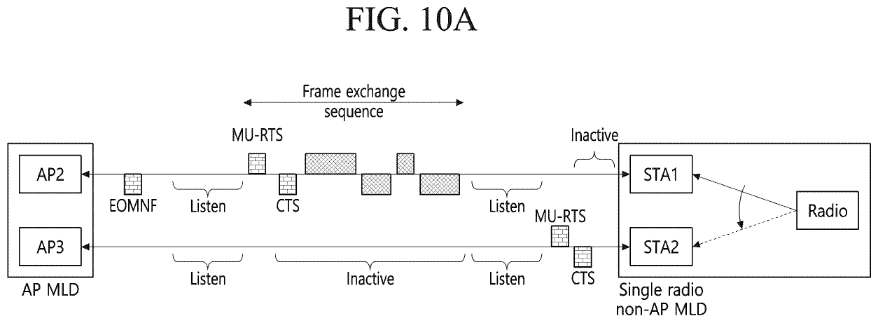

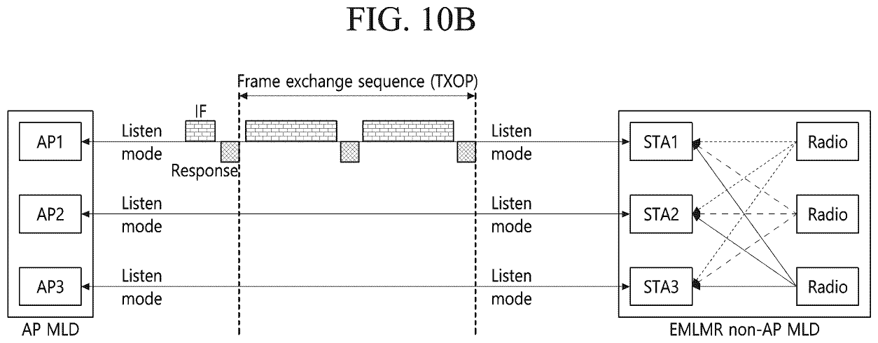

IEEE 802.11be supports multiple bands of operation, where an access point (AP) and a non-AP device can communicate with each other, called links. Thus, both the AP and non-AP device may be capable of communicating on different bands/links, which is referred to as multi-link operation (MLO). Devices capable of MLO operation are referred to as multi-link devices (MLDs). For improving channel access capability with limited hardware cost and power consumption in MLO devices, IEEE 802.11be also supports an operating mode for a non-AP MLD device called enhanced multi-link single radio (EMLSR) mode. In EMLSR mode, a non-AP device behaves like a single radio device that can perform channel sensing and reception of elementary packets on multiple bands/links simultaneously but can perform reliable data communication on one link at a time. Thus, by opportunistically selecting a link for data-communication where it wins the channel contention, EMLSR can improve system spectral efficiency. The operating procedure for EMLSR links is defined in the current 802.11be standard draft and is illustrated in FIG. 10A in accordance with an embodiment. In recent discussions for 802.11bn, an extension to this mechanism to support EMLSR operation for a single link device has also been proposed, which is referred to as single-link EMLSR operation. Note that single-link EMLSR operation is identical to DPS operation for a non-AP STA.

For improving the supported MCS and NSS opportunistically and thus to improve spectral efficiency, IEEE 802.11be also supports an operating mode for a non-AP MLD device called enhanced multi-link multi-radio (EMLMR) mode. Upon start of a frame exchange sequence with the AP on a first link, a non-AP MLD in EMLMR mode can move radios across from its other links to the first link, to improve the supported MCS and NSS on that link. The set of links at an EMLMR non-AP MLD that have this capability to move radios to/from are referred to as EMLMR links. The operating procedure for a non-AP MLD in EMLMR mode is defined in the current 802.11be standard draft and is illustrated in FIG. 10B in accordance with an embodiment.

Embodiments in accordance with this disclosure may assume a BSS with an AP and one or more associated STAs. The AP may support a wider maximum BSS bandwidth than some of the associated STAs. The AP and some of the STAs may support Dynamic Subchannel Operation (DSO). In DSO, upon winning channel access, in the beginning of a TXOP the AP can provide an indication to the DSO STAs the Sub-band on which it intends to serve them within the TXOP or SP. In some embodiments, the sub-band can be, for example, either a 20 MHz channel or a resource unit (RU), that is a part of the frequency on which the channel access has been won and which can even be outside of the primary channel the STA monitors. In some embodiments, the sub-bands may also be referred to as sub-channels. Upon receiving the indication, the indicated STAs may switch to the indicated sub-band for the remaining duration of the TXOP or SP to receive frames from the AP. This mechanism can help efficiently utilize the full BSS bandwidth of the AP, when the associated STAs support a smaller bandwidth. In some embodiments, the AP may also be a multi-link device and some of the DSO STAs may also be capable of operating in EMLSR or EMLMR modes. Although several embodiments herein are provided where the SBS IC frame is a MU-RTS frame, this should not be considered as a limitation of the disclosure. Similar fields can also be used in other choices of SBS IC frames such as Block Ack Request (BAR) frames, Buffer Status Report Poll (BSRP) frames, among other frames and their corresponding response frames. Embodiments in accordance with this disclosure may be applicable to other device modes that involve changing a device's operating bandwidth like dynamic power save operation, single link enhanced multi-link multi-radio operation or non-primary channel access operation, among other operations.

Although several embodiments in accordance with this disclosure are described in relation to UHR generation of the Wi-Fi standard, embodiments in accordance with this disclosure can be applicable to other versions of different standards, including the IEEE Wi-Fi standard, non-Wi-Fi standards (e.g., Wi-Fi aware, Wi-Fi direct, among others).

Described herein is the SBS IC frame format in accordance with some embodiments. In some embodiments, upon winning a wide bandwidth TXOP, it may be desirable to serve DSO clients on secondary channels and non-DSO clients on primary channels.

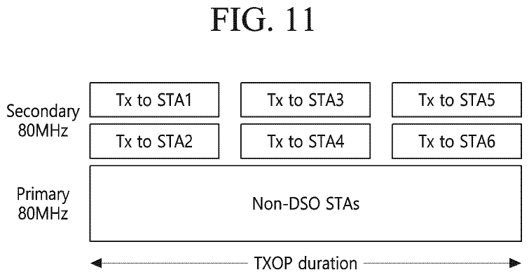

FIG. 11 illustrates an example of serving DSO devices on a secondary channel and non-DSO STAs on a primary channel in accordance with an embodiment. In particular, FIG. 11 illustrates serving of DSO devices on the secondary 80 MHz and non-DSO STAs on the primary 80 MHz channels in a 160 MHz TXOP. As illustrated, the DSO devices including STA1, STA2, STA3, STA4, STA5 and STA6.

In some embodiments, if the SBS IC frame solicits a response, then both DSO and non-DSO devices should respond to ensure TXOP protection for the full bandwidth. In some embodiments, it may be desirable to design the SBS IC in a frame format that can also solicit a response from pre-11bn devices.

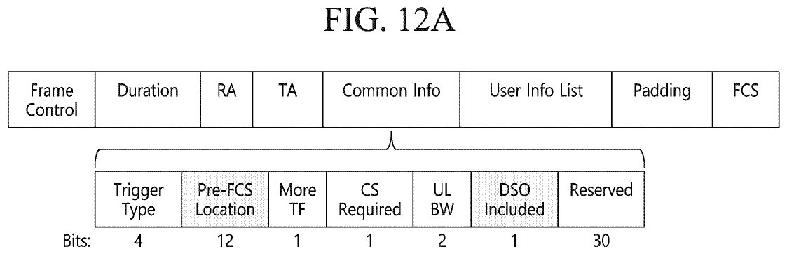

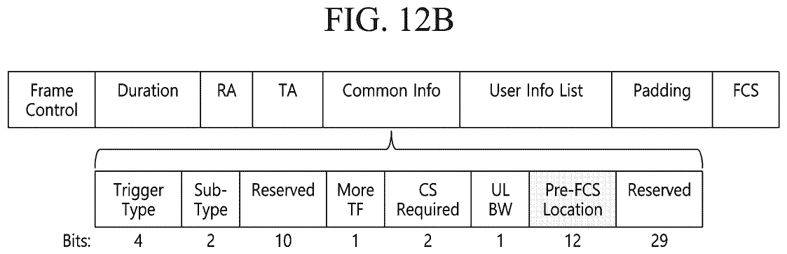

In some embodiments, an MU-RTS frame may be used as the SBS IC frame for DSO devices. FIG. 12A illustrates a Common Info field of the MU-RTS frame as an SBS IC in accordance with an embodiment. The MU-RTS frame includes a Frame Control field, a Duration field, a Receiver Address (RA) field, a Transmitter Address (TA) field, a Common Info field, a User Info list field, a Padding field, and a Frame Check Sequence (FCS) field. The Common Info field includes a Trigger Type field, a Pre-FCS Location field, a More TF field, a CS Required field, a UL BW field, a DSO Included field, and one or more reserved fields.

The Frame Control field provides frame control information for the frame including version, type, subtype, among other information. The Duration field provides duration information. The RA field provides the address of the one or more recipient STAs. The TA field provides the address of the transmitting STA. The Common Info field provides parameters that are common to all the addressed STAs, and includes various subfields as described below. The User Info List field provide RU allocation to one or more AIDs, and include several subfields as described below. The Padding field may provide padding information. The FCS (frame control sequence) field may provide error detection information.

The Trigger Type field may provide information regarding a type of the trigger frame. The More TF field may provide information about whether more follow-up trigger frames are present. The CS Required field may enable/disable the CS required. It is set to On to indicate that the STAs identified in the User Info fields are required to use ED to sense the medium and to consider the medium state and the NAV in determining whether or not to respond. The CS Required subfield is set to Off to indicate that the STAs identified in the Per User Info fields are not required consider the medium state or the NAV in determining whether or not to respond. The UL BW field sets the bandwidth of the PPDU. The reserved field is reserved.

Certain fields illustrated in the subsequent figure, including FIGS. 12B, 13, 14A-F, 24 and 25, may be the same as those described in prior figures, including in FIG. 12A and their description has been omitted in the subsequent figures.

FIG. 12B illustrates another example of a Common Info field of the MU-RTS frame as an SBS IC in accordance with an embodiment. In FIG. 12B, the MU-RTS frame includes a frame control field, a duration field, a receiver address (RA) field, a transmitter address (TA) field, a common info field, a user info list field, a padding field, and a frame check sequence (FCS) field. The common info field may include a trigger type field, a sub type field, a reserved field, a more TF field, a CS required field, a UL BW field, a pre-fcs location field, and a reserved field. In some embodiments, pre-11bn devices may also be addressed using such an MU-RTS frame. In some embodiments, the reserved fields of the Common Info field and the User Info fields of the MU-RTS frame can be used to provide the necessary information for DSO sub-band switch operation. The Common Info field can have a “DSO Included” field as illustrated in FIG. 12A, or a “Sub-type” field as illustrated in FIG. 12B, to indicate that the MU-RTS frame is an SBS IC frame. Such a field can have a specific length (e.g., 1-4 bits), and a specific bit sequence may indicate the fact that the MU-RTS includes some DSO specific User Info fields.

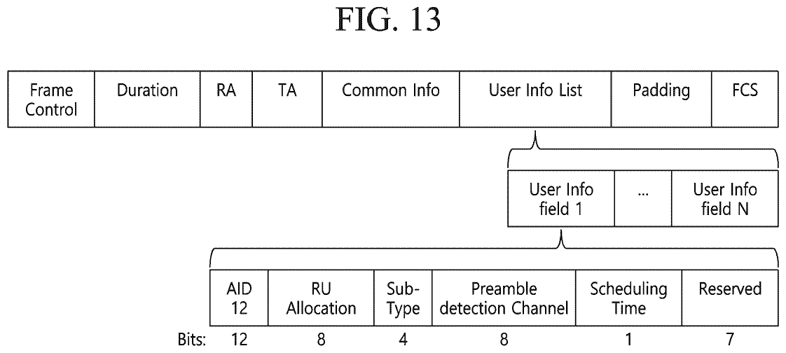

FIG. 13 illustrates a User Info field of the MU-RTS frame as an SBS IC in accordance with an embodiment. A user info field may include an AID 12 field, a RU allocation field, a sub-type field, a preamble detection channel field, a scheduling time field, and a reserved field.

In some embodiments, the User Info list of the MU-RTS frame can have several User Info fields, and some of them may be DSO-specific User Info fields. DSO-specific User Info fields may be addressed to DSO STAs for which the AP intends to request a sub-band switch. The reserved fields of the User Info field in a conventional MU-RTS frame may be used for indicating DSO parameters in the DSO-specific User Info field. One of the parameters of such a User Info field can be a “DSO-specific” field or a “Subtype” field of a specific length (e.g., 1-4 bits), and a specific encoding of this field can indicate that the User Info field is a DSO-specific field. Another DSO-specific parameter can be a Scheduling Time field that can be set to ‘0’ or ‘1’ to indicate whether the AP intends to perform frame exchanges with the indicated STAs immediately or later within the TXOP, respectively. In some embodiments, the STAs with which the AP intends to perform frame exchanges immediately may be required to respond to the MU-RTS frame. Yet another DSO-specific parameter can be the Preamble Detection Channel field that indicates the 20 MHz temporary primary channel where the addressed DSO STA is expected to perform preamble detection. In some embodiments, if a DSO STA is addressed by the MU-RTS but it is not expected to perform sub-band switch (e.g., it is served on the primary channel), then the DSO-specific parameters may not be included in the User Info field corresponding to that STA's AID.

In some embodiments, when the RU Allocation field indicates an RU outside of the primary channel, it may be implicitly inferred that the User Info field is a DSO-specific User Info field. Correspondingly, a Subtype field or a DSO-specific field may not be required.

In some embodiments, the BAR frame or the BSRP trigger frame may be used as the SBS IC and may use similar fields as above in the Common Info and User Info fields to provide the DSO specific parameters.

In some embodiments, Frame Check Sequence (FCS) check may be enabled while using a padding field. In some embodiments, after obtaining the sub-band allocation indications in the SBS IC frame, the DSO devices may perform the channel switch to the indicated channel. In order to protect the wireless medium while the DSO STAs perform the channel switch, the AP may transmit some signal on the wireless medium on all the bands of the TXOP for sufficient time.

In some embodiments, the SBS IC may not solicit a response from the non-AP STAs and the required padding for the switch may be provided in a follow-up frame transmitted afterwards.

In some embodiments, where the SBS IC frame is an MU-RTS frame, the MU-RTS can be sent in a PPDU format that allows aggregation, where a follow up padding frame can be used in the A-MPDU as this medium-reserving signal. In some embodiments, where the SBS IC frame is the MU-RTS frame, this medium-reserving transmission on the medium can be the Padding field of the MU-RTS frame. However, since the Padding field precedes the Frame Check Sequence (FCS), the DSO STAs may not be able to receive the FCS field at the end of the frame to perform FCS check if they switch during the Padding field.

In some embodiments, DSO STAs may be expected to perform the sub-band switch without performing the FCS check on the MU-RTS frame.

In some embodiments, the AP can include a “pre-FCS” field in the User Info List of the MU-RTS frame or other trigger frame used as the SBS IC frame that can be used by DSO devices for performing frame check. Since User Info List comes before the padding, the DSO devices can perform the frame check using this pre-FCS check field and then perform the sub-band switch during the padding. The pre-FCS field can also have other names, such as the Intermediate FCS (I-FCS) field.

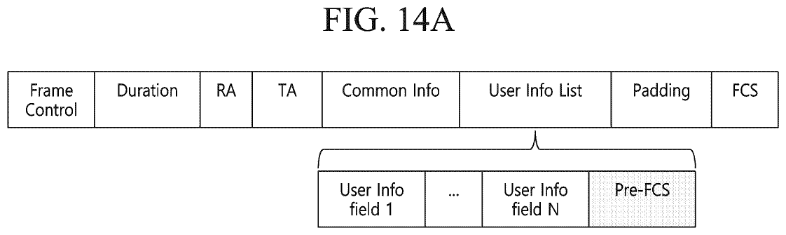

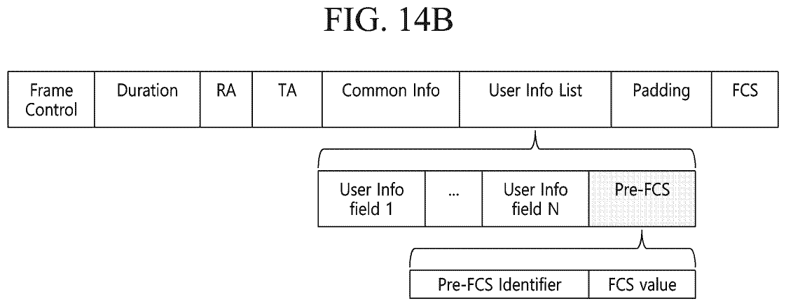

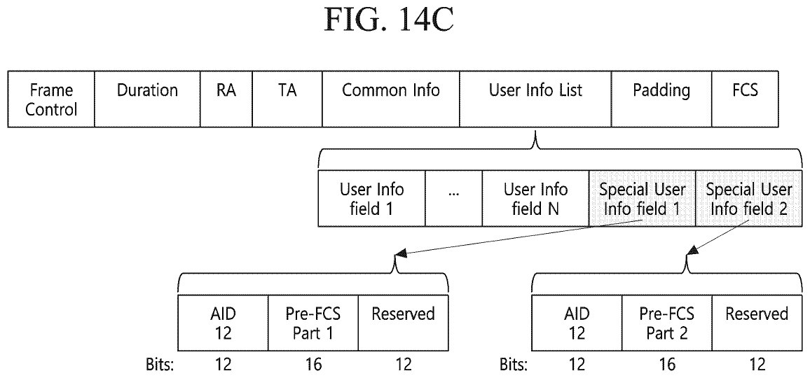

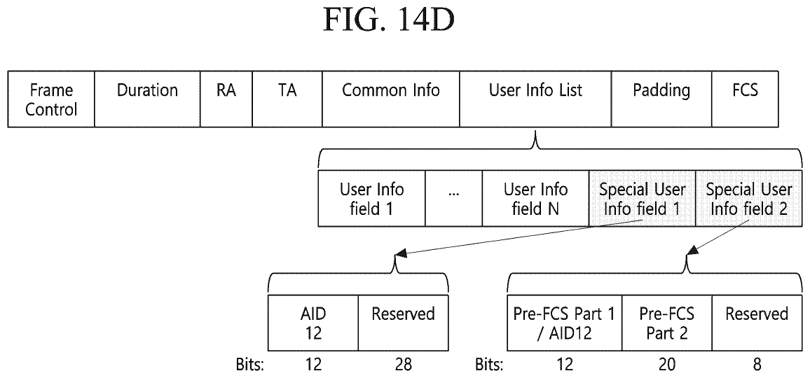

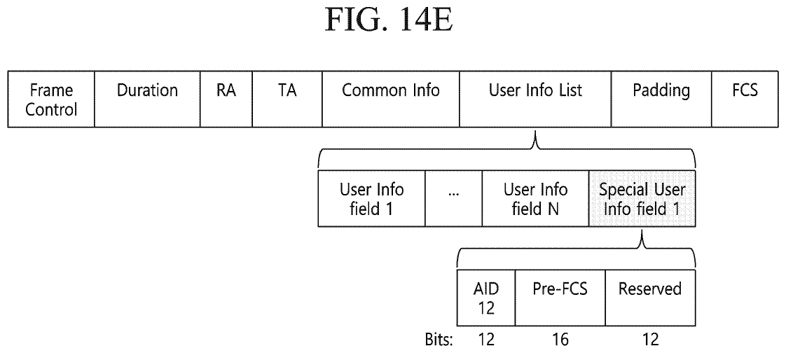

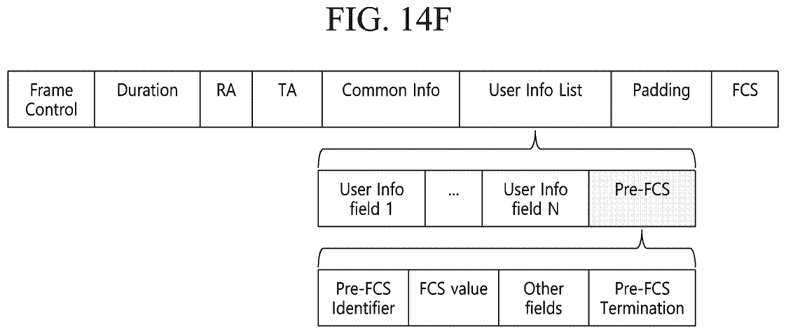

FIG. 14A illustrates a Pre-FCS field at the end of the User Info List of the MU-RTS frame in accordance with an embodiment.

FIG. 14B illustrates a Pre-FCS field at the end of the User Info List with inclusion of a Pre-FCS Identifier subfield in accordance with an embodiment.

In some embodiments, there can be a pre-FCS field added at the end of all other User Info fields that address STAs that are expected to respond to the MU-RTS. Legacy devices may interpret this pre-FCS field as part of the padding or as some unknown User Info fields, which can be accomplished, for example, by including a specific sequence in the beginning of the pre-FCS field as illustrated in FIG. 14B in accordance with an embodiment. The FCS value of the pre-FCS field can be computed based on the bits preceding its location in the MU-RTS and not be based on the bits following it. In some embodiments, the Pre-FCS field may have a length of 32 bits that includes a 32 bit FCS value. In some embodiments, the Pre-FCS field may have a length of 40 bits (similar to conventional User Info fields), may include a 32 bit FCS value but may not have an AID12 field. In some embodiments, the Pre-FCS field may have a length greater than or equal to 44 bits, and it may include an AID12 subfield or Pre-FCS Identifier subfield that is assigned a special pre-determined value (to help identify it) and a 32 bit FCS value. For example, the Pre-FCS Identifier subfield can have a length of 2 octets set to all 1s to identify start of Pre-FCS field, as illustrated in FIG. 14B in accordance with an embodiment. This special sequence may also help legacy STAs interpret the Pre-FCS as part of padding.

FIG. 14C illustrates a pre-FCS field as part of two special User Info fields of a MU-RTS frame in accordance with an embodiment. In some embodiments, two adjacent User Info fields in the MU-RTS frame can be jointly used for indicating the pre-FCS value as depicted in FIG. 14C. In some embodiments, each of the two User Info fields may have the conventional length of 40 bits. The first 16 bits of the computed FCS can be included in the first User Info field while the second 16 bits of FCS value can be included in the second User Info field. In some embodiments, the 32 bits of the FCS may be split differently between the two User Info fields (e.g., 28 bits in one field and 4 bits in another field). In some embodiments, the AID12 fields for the User Info fields may be predetermined and can be from the AID range of 2008-2044 or 2047-4094. In some embodiments, the User Info fields may be assigned two consecutive AID12 values. In certain embodiments, to be more efficient, both the User Info fields may share the same AID12 value. In several embodiments, the AP may determine the AIDs of these User Info fields based on its implementation, and the AIDs may not correspond to any other associated STAs. The FCS value of the pre-FCS field can be computed based on the bits preceding the two User Info fields and the AID12 field of the first of the User Info field, and not on the bits transmitted later in the MU-RTS frame. In some embodiments, these special User Info fields can be included after all the User Info fields corresponding to DSO devices.

FIG. 14D illustrates a pre-FCS field in a second of two special User Info fields of a MU-RTS frame in accordance with an embodiment. In some embodiments, two adjacent User Info fields in the MU-RTS frame can be jointly used for indicating the pre-FCS value as depicted in FIG. 14D. In some embodiments, each of the two User Info fields may have a conventional length of 40 bits. In some embodiments, the AID 12 values of the two User Info fields may be predetermined and can be from the AID range of 2008-2044 or 2047-4094. In some embodiments, the AP may determine the AIDs of the User Info field based on its implementation or the value of FCS remainder. The AIDs may not correspond to any other associated STAs. The 12 bits of the AID12 field of the 2nd User Info field and the following 20 bits of the second User Info field may jointly indicate the Pre-FCS value. The FCS value of the pre-FCS field can be computed based on the bits preceding the second User Info field. In some embodiments, the last 28 bits of the first User Info field (after the AID12 field) may be reserved and set to values that ensure that the first 12 bits of the pre-FCS field can match the selected AID12 field of the second User Info field.

In some embodiments, it may also be ensured that the main FCS value (included at the end of the frame) remains unchanged with the inclusion or exclusion of the two Special User Info fields from the frame. This may be to enable parallel computation of the FCS and pre-FCS values. It can be achieved by intelligently designing the reserved/unused bits of the two Special User Info fields to achieve this feature, or by including a 3rd Special user info field after the 2 Special User Info fields and designing its bits to achieve this feature. In some embodiments the Pre-FCS value may be appended with 32 bits that match the 32-bit FCS remainder generated by the MAC frame using bits preceding both the User Info fields.

FIG. 14E illustrates a short Pre-FCS field in one special User Info fields of MU-RTS frame in accordance with an embodiment. In some embodiments, there may be a single Special User Info field for carrying the pre-FCS. In some embodiments, the pre-FCS polynomial can be chosen to be of degree 32 but the most significant 28 bits of the remainder (upon performing FCS computation on all bits of the MU-RTS frame up to and including the AID12 of the Special User Info field) can be carried in the remaining 28 bits of the User Info field. The DSO receiver may correspondingly declare the frame as being correct if the most significant 28 bits of the FCS check remainder are all 0 (last 4 bits of the remainder are ignored). In some embodiments, instead of the most significant 28 bits, the least significant 28 bits may be carried in the pre-FCS field. In some embodiments, the pre-FCS polynomial can be chosen to be of a length smaller than or equal to 28 bits and thus one Special User Info field can be sufficient for the indication. For example, a pre-FCS polynomial of degree 16 can be used and 16 bits of the 28 bits of the Special User Info field after the AID12 field can carry the pre-FCS value as shown in FIG. 14E in accordance with an embodiment. Such a pre-FCS value may be computed from all bits of the MAC frame preceding its location including the AID12 field of the special User Info field.

In some embodiments, the pre-FCS field may be a new element of variable length, called 11bn Pre-padding element, and it may carry additional information, apart from the FCS value.

The location of the pre-FCS field may be indicated in the Common Info field of the MU-RTS frame in a “Pre-FCS Location” field as indicated in FIG. 12A or FIG. 12B in accordance with some embodiments. In some embodiments, the location of the pre-FCS field can be indicated by carrying a User Info Count value, that indicates a value of n, if the pre-FCS field is present after f(n) User Info fields, where f(·) is some predetermined function. For example, we can have f(n)=n or f(n)=n+1. In some embodiments, the largest value of the User Info Count field (say N) can indicate that there are at least f(N) User Info fields before the pre-FCS field. For example, the User Info Count field can be of 4 bits, and a value of 15 may indicate presence of at least 16 User Info fields before the pre-FCS. In some embodiments, the location indication may indicate the number of bits in the MAC frame that precede the Pre-FCS field with a certain level of granularity (e.g., octets).

In some embodiments, the location can be indicated by carrying the AID of the first of the two adjacent User Info fields that carry the pre-FCS. In some embodiments, a Pre-FCS location indication may not be necessary where the AIDs corresponding to the Pre-FCS field or its location in the frame is predetermined. In some embodiments, a special encoding value of this field may indicate that the Pre-FCS is not present in the frame. In certain embodiments, a separate field called ‘Pre-FCS Present’ may be present to indicate whether or not the pre-FCS is present in the frame. Correspondingly, the Pre-FCS count field may be optionally present when Pre-FCS Present is set to 1. In some embodiments, instead of a pre-FCS field a Message Integrity Check field or other similar security check can be added to the User Info List.

Although the above examples of pre-FCS demonstrated its use and location for an MU-RTS frame, they may also be included in other trigger frames, such as BAR, BQRP and BSRP frames, among others that are used as SBS IC frames.

Although the above examples focused on DSO devices, as also highlighted previously, the mechanisms are also applicable to other modes of operation where an AP or a non-AP STA may change its operating channel or bandwidth after receiving a trigger frame, such as single-link EMLSR operation, DPS operation, NPCA operation, among others. Correspondingly, such a trigger frame initiating the bandwidth switch may include the aforementioned fields and features.

Behavior of other non-AP STAs in accordance with this disclosure is described herein. In some embodiments, a UHR STA that is not performing any bandwidth switch or operating channel width change may use the Pre-FCS value to perform an early validation of the correctness of the trigger frame. Correspondingly, it may choose early termination of the decode process of the rest of the trigger frame. This may happen, for example, if the correctness check on the Pre-FCS fails. In another example, if a non-AP UHR STA is not expected to be address by the trigger frame (e.g., the transmit address is from an unknown AP), it may early terminate the decoding process of the trigger frame even if the correctness check on the Pre-FCS passes. In some embodiments, a PHY primitive can be used to indicate to the PHY to early terminate a reception process. When the correctness check on the Pre-FCS passes, the non-AP STA may get a valid NAV duration that can be used. In some embodiments, to use the above behavior, the non-AP STA may have to apriori indicate to the AP about its choice to early terminate decoding of trigger frames including pre-FCS. This indication can be done during association or later on, for example, by setting a capability bit to 1 or by transmitting a notification frame. In some embodiments, the transmitting STA may not carry any indication after the Pre-FCS field of the trigger frame, that is intended for UHR STAs or beyond UHR STAs that are expected to early terminate the decode process of the trigger frame.

FIG. 14F illustrates a special sequence indicating the termination of the pre-FCS field (or beginning of padding field) for UHR STAs in accordance with an embodiment. In some embodiments, the end of the Pre-FCS field may also be indicated by a specific bit sequence, which indicates the start of padding from the perspective of 802.11bn STAs. An example of this design is depicted in FIG. 14F, where the Pre-FCS Termination field may be a sequence of 2-octets length. 802.11bn STAs, after observing this specific sequence at the end of the Pre-FCS may consider the rest of the bits of the trigger frame as reserved or padding bits. This mechanism may be used as a method to define new fields in trigger frames in future Wi-Fi generations, that are not interpretable by 802.11bn STAs.

In some embodiments, the trigger frames meant for bandwidth switching may be transmitted in non-HT duplicate PPDU format, which may not include the NAV information in the PHY header. Correspondingly, a STA from a neighboring BSS may need to decode the whole trigger frame to validate it and also validate the NAV value indicated in the frame, which can lead to significant waste of power, especially for longer trigger frames with a lot of padding. Accordingly, in some embodiments, the trigger frames may carry a preliminary FCS value that is carried in a User Info field with a pre-defined AID value, and may be present early within the trigger frame. For example, the User Info field with the preliminary FCS value may be present before any of the User Info fields that address non-AP STAs associated with the AP. In some embodiments, the User Info field can be the same as the Special User Info field that carries the extension of Common Info field, or it can be an extension of the Special User Info field. This preliminary FCS value may be computed based on the bits that occur before the preliminary FCS field. Non-AP UHR STAs that are not expected to be addressed by the trigger frame (e.g., the transmit address is from an unknown AP) may use this preliminary FCS value to early terminate the decoding process of the trigger frame.

In some embodiments, the preliminary-FCS may be a separate field that is carried in the trigger frame in addition to the Pre-FCS/Intermediate FCS that is described above.

In some embodiments, a UHR device transmitting a trigger frame may include at least one of a Preliminary FCS or a Pre-FCS value within a trigger frame that it transmits, if the length of the trigger frame is above a pre-determined threshold. In some embodiments where the presence of the Preliminary FCS is optional within a UHR variant of a Trigger frame, there may be a Preliminary FCS Present bit in the Common Info field (or Special User Info field that extends the Common Info), indicating whether a Preliminary FCS field is present in the frame.

In some embodiments, where the NAV for a transmit TXOP has already been indicated by the transmission of a different frame (e.g. RTS/CTS among others) before transmission of the trigger frame, and the trigger frame is not updating the TXOP duration, the Preliminary FCS may not need to be carried within the trigger frame.

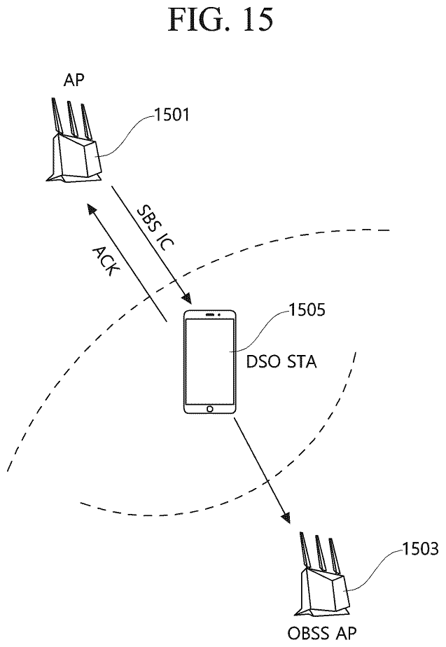

FIG. 15 illustrates a hidden node problem for DSO operation in accordance with an embodiment. In some embodiments, there can be hidden node issue in DSO operation. For example, consider the case that an AP 1501 is out of the coverage range of a neighboring overlapping basic service set (OBSS) AP 1503 and thus may detect the channel as idle. The AP 1501 may, thus, transmit an SBS IC to a DSO STA 1505, asking the STA to switch to the same sub-band as the OBSS AP 1503, as depicted in FIG. 15. After performing the switch to the sub-band, if the DSO STA 1505 directly transmits a clear-to-send (CTS), it may cause packet failure at the neighboring AP. In some embodiments, the DSO STA 1505 may need to switch to the indicated sub-band and perform energy detection and/or preamble detection on the new sub-band for a pre-determined amount of time after the end of the SBS IC frame before sending the CTS frame. This predetermined amount of time can be the Short Inter-frame Spacing (SIFS) duration. The AP can indicate that the DSO STA needs to perform such an operation by setting the CS Required subfield of the Common Info field of the MU-RTS frame to 1. In some embodiments, the energy detection threshold can also be reduced to be more conservative, e.g., −72 dBm or −82 dBm when performing energy detection on the new sub-band after performing the sub-band switch. Similar mechanism may also be adopted for responses to other types of trigger frames, such as, BSRP frame among others.

In some embodiments, the AP may not solicit a response from the non-AP STA for the SBS IC frame. After the sub-band switch is performed, the AP may transmit a second MU-RTS frame or an RTS frame to solicit a response from the STA and thus detect hidden node issues, before performing data transmissions.

In some embodiments, the SBS IC may be a trigger frame and it may solicit a response from one or more DSO STAs and one or more non-DSO STAs. These STAs may be identified, for example, in the User Info fields of the SBS IC frame.

In some embodiments, where the SBS IC is an MU-RTS frame, the CTS response frame may be required to be transmitted at a specific Modulation and Coding Scheme (MCS) value and in a specific PPDU format. In some embodiments, the CTS frame may be transmitted in a non-HT duplicate PPDU format. In certain embodiments, the format of the CTS response may be different for DSO and non-DSO STAs. For example, the non-DSO STAs may respond with a CTS in a non-HT duplicate PPDU format while the DSO STAs may respond in a ‘modified’ non-HT duplicate PPDU format. Here the modified non-HT duplicate PPDU format may be similar to the non-HT duplicate PPDU format, except that the transmission may occupy a one or more non-primary channels without overlapping with the primary channel of the TXOP. The RUs which the CTS response transmitted by a DSO STA in ‘modified’ non-HT duplicate PPDU format may be indicated in the User Info field of the SBS IC frame corresponding to the DSO STA. For example, the indication can be carried in the RU Allocation subfield of User Info field. In some embodiments, not all STA addressed in the SBS IC frame may be required to respond to the SBS IC frame. In certain embodiments, if no CTS response is received to the MU-RTS on the primary 20 MHz channel, the MU-RTS transmission may be considered as having failed. In some embodiments, if a successful CTS response is received on any 20 MHz subchannel of the TXOP bandwidth, the MU-RTS may be considered as being successful. In certain embodiments, if no response to SBS IC frame (e.g., CTS) was received on the primary 20 MHz channel, the AP may transmit padding bits on the primary 20 MHz channel for the duration of the downlink frame transmissions that it performs on the other 20 MHz sub-bands where a response was received successfully. Embodiments in accordance with this disclosure may also be applicable to BSRP frames and its applicable response frames.

In some embodiments, where the SBS IC is a BSRP frame, the response frame may be a trigger-based PPDU (TB-PPDU) that includes a QoS Null frame that carries a Buffer Status Report (BSR). Additional steps may be taken to reduce the impact of inter-carrier interference (ICI) generated by the TB PPDU transmitted by DSO STAs. In some embodiments, the TB PPDU may be required to be transmitted in a specific MCS and/or a specific PPDU format. As with conventional BSRP response, the TB PPDU sent by a DSO STA, may be transmitted on the resource units as indicated in the RU Allocation subfield of the User Info field corresponding to the DSO STA. In some embodiments, the TB PPDU may not be allowed to have aggregation of data frames within it. In certain embodiments, the TB PPDU may be restricted in its maximum duration. In some embodiments, the number of null subcarriers at the end of the assigned RUs for the TB PPDU by DSO STAs may be increased to reduce the inter-carrier interference. In some embodiments, the response frame may also be a multi-STA block ACK frame. This can be, for example, if the SBS IC requests the use of such a response frame and/or if the responding STA intends to transmit additional information regarding its unavailability, required resources for transmitting buffered data, among other operations.

Enabling power pre-correction of a response frame in accordance with this disclosure is described herein. In some embodiments, where the SBS IC is the MU-RTS frame, the response frame for the responding STAs may be transmitted at the maximum allowed power of the responding STA (subject to other rules or constraints).

In some embodiments, where the SBS IC is the BSRP frame, the response frame may need to be transmitted with power pre-correction, if indicated to do so in the UL Target Received Power subfield of the SBS IC frame. A regular non-DSO STA calculates the transmit power for the response as: Tx_{pwr}^{STA}=PL_{DL}+TargetRx_{pwr}, where PL_{DL} is the pathloss computed from the received SBS IC. In the case of a DSO STA, since the response may be transmitted on a different sub-band from where the SBS was received, the DSO STA may not be able to know the correct value of PL_{DL} to be used for determining the transmit power for the response TB PPDU. To resolve this issue, in some embodiments, the UL Target Receive Power subfield of the SBS IC frame may be set to 127, to enable the STA to use its maximum allowed transmit power. In certain embodiments, a mapping function may be proposed to map the measured pathloss on the primary 20 MHz channel by a DSO STA to the pathloss expected by the DSO STA on the new sub-band after the sub-band switch. This mapping may be, for example, a conservative estimate as given by Equation 1:

$$P {L}_{D L} = P {L}_{D L , p 20} + P \qquad ( 1 )$$

Where PL_{DL} is the desired pathloss to be estimated on the new subband, PL_{DL,p20} is the pathloss estimated on the primary 20 MHz channel, and P is a predetermined constant, e.g., 3 dB or 0 dB. Correspondingly, the DSO STAs may use this value of PL_{DL} to compute the allowed transmit power Tx_{pwr}^{STA} for the TB PPDU.

In some embodiments, the DSO STA, after subband switching, may acquire the DL received signal power measurement using the remaining portion of the SBS IC frame, such as the remaining OFDM symbols. In order to do so, the DSO STA may indicate a DSO Padding Delay value that is long enough for it to be able to receive the necessary OFDM symbols of the SBS IC frame after performing the DSO sub-band switch. In certain embodiments, a known signal of a given power level may be transmitted during at least a portion of the remaining frame, e.g., at a predetermined OFDM symbol location. A DSO STA then may use this known signal to acquire or refine the received signal power measurement, and correspondingly the pathloss PL_{DL} on the assigned sub-band. DSO STAs may use this value to then determine the transmit power for the response Tx_{pwr}^{STA}.

Enabling time synchronization of a response frame in accordance with this disclosure is described herein.

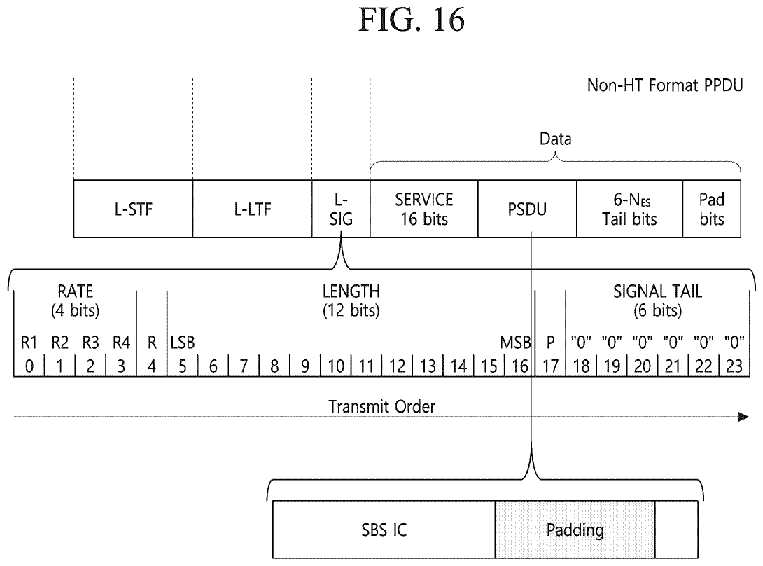

FIG. 16 illustrates a PPDU carrying an SBS IC frame and its PHY-preamble including the L-SIG field in accordance with an embodiment. The non-HT PPDU includes a preamble that includes a legacy short training field (L-STF), a legacy long training field (L-LTF), and a legacy signal field (L-SIG), and a data portion that includes a service field, a PSDU field, a 6 tail bits field, and a Pad bits fields.

The L-STF field is the first field of the OFDM PLCP legacy preamble and may be used for packet detection and coarse frequency offset.

The L-LTF field is the second field of the preamble and can be used to timing synchronization and fine frequency offset.

The L-SIG field includes one OFDM symbol with a duration that varies with channel bandwidth. The L-SIG may include packet information for a received configuration. Bits 0 through 3 may specify the data rate (modulation and coding rate) for the non-HT format. Bit 4 may be reserved for future use. Bits 5 through 16: for non-HT formats, specify the data length (amount of data transmitted in octets); For HT-mixed formats, specify the transmission time; for VHT formats, specify the transmission time. Bit 17 has the even parity of bits 0 through 16. Bits 18 through 23 contain all zeros for the signal tail bits.

The service field may include 16 zeros to initialize the data scrambler.

The PSDU field may be a variable-length field that includes the physical layer convergence protocol (PLCP) service data unit (PSDU).

The 6 Tail bits field may be required to terminate a convolutional code. The field uses six zeros for the single encoding stream.

The Pad Bits field may be a variable-length field required to ensure that the non-HT data field includes an integer number of symbols.

In some embodiments, the SBS IC frame can be a trigger frame. After receiving a trigger frame, a STA that transmits a HE TB PPDU, non-HT PPDU, or non-HT duplicate PPDU in response may ensure that the transmission start time of the HE TB PPDU, non-HT PPDU, or non-HT duplicate PPDU is within ±0.4 μs+16 μs from the end, at the STA's transmit antenna connector, of the last OFDM symbol of the triggering PPDU (if it contains no PE field) or of the PE field of the triggering PPDU (if the PE field is present). In DSO operation, since the DSO device stops decoding the SBS IC frame before the padding field and switches to a new channel (where it doesn't have a channel estimate), it may not be able to continue receiving the rest of the trigger frame to identify the end of the frame. Correspondingly, in some embodiments, the DSO STAs may use the L-SIG field of the PPDU including the SBS IC (as illustrated in FIG. 16) to determine the duration of the PPDU and start a count-down timer of that duration. In some embodiments, before setting the count-down timer, the DSO STAs may modify this duration value to account for the symbol timing offset of the transmitting device, which can be estimated from the parameters of the SBS IC. The expiry time of this timer may be used as an indication of the end of the trigger frame PPDU, and the STAs may respond with the CTS a fixed duration of time (such as SIFS time or 16 μs time) after that expiry time on the new channel. In some embodiments, the Common Info field of the MU-RTS frame may include a new “Response Time” subfield used to indicate the exact time (counting from the start of the PPDU containing the MU-RTS frame) when the response CTS should be transmitted.

In some embodiments, the DSO STA, after subband switching, may acquire or refine OFDM symbol timing using the remaining portion of the SBS IC frame, such as the remaining OFDM symbols. A known signal may be transmitted during at least a portion of the remaining frame, e.g., at a predetermined OFDM symbol location. DSO STA then may use this known signal to acquire or refine the symbol timing.

Enabling frequency synchronization of a response frame in accordance with this disclosure is described herein. In some embodiments, the SBS IC frame can be a trigger frame. In some embodiments, after receiving a trigger frame, a STA may be required to compensate for carrier frequency offset (CFO) error and symbol clock error with respect to the corresponding triggering PPDU when transmitting the following types of PPDUs: HE TB PPDU, and Non-HT or non-HT duplicate PPDU with the TXVECTOR parameter TRIGGER_RESPONDING set to true. After the frequency compensation, the absolute value of residual CFO error with respect to the corresponding triggering PPDU may not exceed the following levels when measured at the 10% point of the complementary cumulative distribution function (CCDF) of CFO errors in AWGN at a received power of −60 dBm in the primary 20 MHz:
350 Hz for the data subcarriers of an HE TB PPDU (This may be applicable to BSRP frame or other non-MU-RTS trigger frames);
2 KHz for a non-HT PPDU or non-HT duplicate PPDU (This may be applicable to MU-RTS frame).

For DSO devices, since the sub-band switch involves changing of oscillator frequency, this operation may cause a change in the CFO value of the DSO device. Thus, any CFO compensation factor calculated from the received SBS IC frame before performing the sub-band switch may not be applicable any more after performing the sub-band switch. If the DSO STA transmits the response frame to the SBS IC frame directly based on this wrong CFO compensation factor, it may cause a violation of the aforementioned requirements and cause significant inter-carrier interference.

Correspondingly, in some embodiments, a BSRP frame may not be used as an SBS initial control frame for DSO devices since its CFO requirements may be too stringent (350 Hz). The MU-RTS frame may be used as an SBS IC since its requirements are less stringent (2 KHz). In some embodiments, the CFO error requirements for response to BSRP may be lowered for UHR devices to allow higher CFO values when the trigger frame solicits a response from DSO devices. In certain embodiments, additional constraints may be levied on the TB PPDU transmitted by the DSO STAs in response to the BSRP frame to allow for the lowered CFO error requirements. For example, some embodiments may have one or more of the following constraints on the response frame.

In some embodiments, the RU size allocated to a DSO STA in the BSRP may be larger than a minimum value, e.g., 20 MHz or 242 tones.

In some embodiments, in the allocated RUs to a DSO STA, additional null subcarriers (then those used by non-DSO STAs) may be required to be used by the DSO STA during the transmission of the response frame.

In some embodiments, in the allocated RUs to a DSO STA, additional pilot subcarriers (then those used by non-DSO STAs) may be required to be used by the DSO STA during the transmission of the response frame. In some embodiments, there may be a constraint on the maximum length/duration of the response frame.

In some embodiments, the response frame may be required to be transmitted by all or some of the STAs at a lower (and thus more robust) MCS values and/or in a specific PPDU format. The STAs may include, for example, the DSO STAs or non-DSO STAs which are assigned RUs adjacent to the DSO STAs in the BSRP frame. In some embodiments, the response frame may not be allowed to have aggregation of data frames within it.

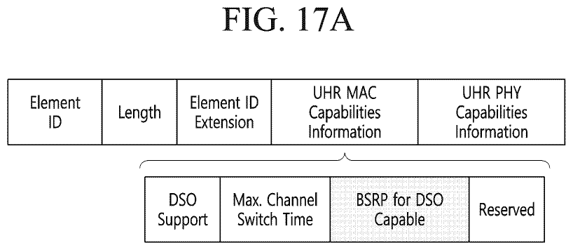

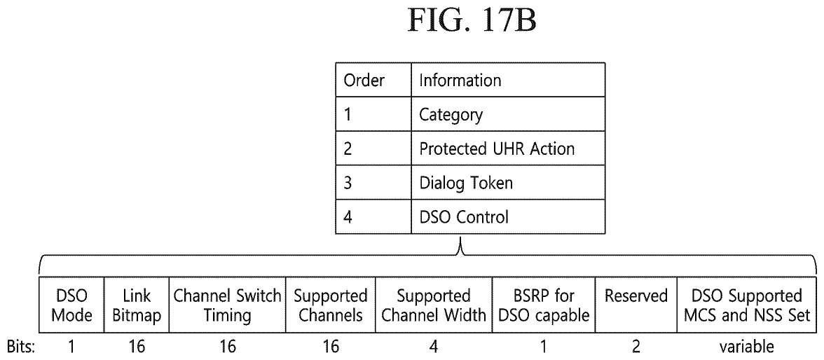

In some embodiments, some implementations of DSO devices may be capable of performing accurate CFO compensation to transmit a response to a BSRP frame as an SBS IC frame, while others may not be able to do so. Correspondingly, in some embodiments, a DSO device may indicate in its UHR capabilities element (that it transmits in probe request and association response frames among others) whether it is capable of receiving BSRP frame as an SBS initial control frame as shown in FIG. 17A in accordance with an embodiment.

FIG. 17A illustrates an example of indication of whether a DSO device can receive BSRP as SBS IC in the UHR Capabilities element in accordance with an embodiment. The frame includes an element ID field, a length field, an element ID extension field, a UHR MAC capabilities information field, and a UHR PHY Capabilities information field. The UHR MAC Capabilities information field includes a DSO support field, a max channel switch time field, a BSRP for DSO capable field, and a reserved field.

The Element ID may provide an identifier of the element. The Length field may provide length information of the element. The Element ID Extension field may provide extension information of the element. The UHR MAC Capabilities Information field may provide capabilities information of the element and can include several subfields as described below.

The DSO Support field may provide information regarding whether DSO is supported. The Max. Channel Switch Time field may provide information regarding a maximum channel switch time that the AP is willing to accommodate for any STA intending to operation in DSO mode. In some embodiments, the AP may also indicate in its UHR Capabilities the maximum Channel Switch Time it is willing to accommodate for any STA intending to operate in DSO mode. In certain embodiments, the Max allowed Channel Switch Time for DSO may be predetermined by the standard, and so this field may not be present. The Reserved field may be reserved.

The BSRP for DSO Capable bit field can provide an indication regarding whether a DSO device can receive BSRP as SBS IC frame, that is set to 1 to indicate that the DSO device is capable of receiving a BSRP frame as an SBS IC frame and is set to 0 otherwise. In certain embodiments, the capability to support BSRP reception may differ for each STA of an MLD, and so the BSRP for DSO Capability field can be distinct for each STA. This can either be indicated by using a BSRP for DSO Capable Bitmap, or by including the BSRP for DSO Capable field in the Per STA Profile of the Basic Multi-link element transmitted by the MLD. In some embodiments, the DSO device may provide this indication in the DSO Notification frame that is transmitted by it to switch to DSO operation mode.

FIG. 17B illustrates a DSO Notification frame that includes an indication regarding whether a DSO device can receive a BSRP as SBS IC frame in accordance with an embodiment. In some embodiments, a DSO STA may be able to meet the CFO requirements for the response to a BSRP SBS IC frame for specific type of sub-band switches. The restriction may be, for example, that the difference in the center frequencies of the two channels (before and after switching) should be below a given threshold value. This threshold value may be indicated by the DSO STA in its UHR Capabilities element or the DSO Notification frame. In some embodiments, a DSO STA may pre-negotiate with the AP to select a set of M sub-band switches for which it is capable of performing CFO correction and meeting the CFO requirements for the response to the BSRP SBS IC frame.

In particular, FIG. 17B illustrates a DSO Mode Notification frame in accordance with an embodiment. The frame may include a category field, a protected UHR cation field, a dialog token field, and a DSO control field. The category field may provide category information for the frame. The protected ulta-high reliability (UHR) action field may provide UHR action information. The dialog token field may provide token information for the frame. The DSO control field may provide DSO control information and include several subfields as described below.

The DSO control field may include a DSO Mode field, a Link Bitmap field, a Channel Switch Timing field, a Supported Channels field, a Supported Channel Width field, a BSRP for DSO capable field, a Reserved field, and a DSO MCS and NSS Set field.

The DSO Mode field may provide an indication of whether the transmitting STA is switching into or out of the DSO mode. In one example, this can be indicated with a 1-bit DSO mode field.

The Link Bitmap may provide an indication of the links of the non-AP STAs affiliated with the non-AP MLD for which the DSO Mode switch is applicable. In some embodiments, this can be indicated with a 16-bit Link ID Bitmap field. In certain embodiments, it can be indicated using a 4-bit Link ID field.

The Channel Switch Timing field may provide an indication of the time that STAs of the non-AP STA/MLD need to perform the channel switch upon receiving an allocation. In some embodiments, this can be a 2-octet field that indicates the time in units of microseconds. In certain embodiments, this indication can be carried in the Channel Switch Timing field of a Channel Switch Timing element.

The Supported Channels field may provide an indication of the supported sub-channels to which the non-AP STA/MLD is capable of switching to. In some embodiments, this can be indicated in a 16-bit channel bitmap, where each bit corresponds to a 20 MHz channel starting from the lowest such 20 MHz channel within the maximum BSS bandwidth. In certain embodiments, this can be indicated in a Supported Channels element. An indication of the bandwidth of the transmission that the non-AP STA/MLD can support. In some embodiments, this can be indicated using a 4-bit field, with an indication of n if the STA/MLD supports a maximum bandwidth of 20×2ⁿ MHz in DSO Mode. In certain embodiments, this can be indicated in the Supported Channel Width Set field and Extended NSS BW Support field.

The DSO Supported and MCS and NSS Set field may provide an indication of the MCS-NSS set that the non-AP MLD/STA can support after the switch. In some embodiments, this can be indicated in the Supported UHR-MCS and NSS Set field.

In some embodiments, to estimate the CFO value after performing the sub-band switch, the DSO STA may use some of the received OFDM symbols of the SBS IC frame after performing the sub-band switch. In order to do so, the DSO STA may indicate a DSO Padding Delay value that is long enough for it to be able to receive the necessary OFDM symbols of the SBS IC frame after performing the DSO sub-band switch. In some embodiments, during the reception of these OFDM symbols, the DSO STA may track the pilot sub-carriers to estimate the residual CFO value to correct for it. In certain embodiments, 1 or 2 pilot symbols (e.g. similar to LTF field) may be introduced to the SBS IC frame via puncturing between the I-FCS field and the FCS field to aid with the CFO estimation. The location of these symbols may be chosen such that all DSO STAs can perform the channel switch before these symbols are encountered. In some embodiments, these OFDM symbols may be identical symbols and the relative phase rotation between the two identical OFDM symbols may be used for CFO estimation, similar to the process used for estimation from the long training field (LTF). In certain embodiments, the OFDM symbols from the post-forward error correction (FEC) padding or packet extension field may be used for performing the residual CFO estimation. The length of the packet extension field may be, for example 8 μs or 16 μs. In some embodiments, the AP may indicate in the Common Info field (or in the Special User Info field which carries additional common information) of the SBS IC frame if such CFO-tracking OFDM symbols are present within the frame. In some embodiments, the presence indication can be common for both the CFO-tracking OFDM symbols and for the Pre-FCS field. A non-AP DSO STA when enabling DSO operation may indicate to the AP if it requires such CFO-tracking OFDM symbols in the end of the SBS IC frame. This requirement can be for all SBS IC frames or for specific SBS IC frames, e.g., BSRP frame, among others.

In some embodiments, the DSO STA, after subband switching, may acquire or refine the CFO estimate using the remaining portion of the SBS IC frame, such as the remaining OFDM symbols. A known signal may be transmitted during at least a portion of the remaining frame, e.g., at a predetermined OFDM symbol location. A DSO STA then may use this known signal to refine residual CFO estimate after performing the switch.

Although several embodiments in accordance with this disclosure are described for the BSRP frame as an SBS IC frame, the described restrictions, indications and procedures may also be applicable for any other new frame that is introduced as an SBS IC frame.

SBS IC frame cancellation indication in accordance with this disclosure is described herein. In some embodiments, after sending an SBS IC frame indicating sub-band switch to DSO STAs, the AP may determine that it needs to end the transmission opportunity (TXOP). This may happen, for example, if no response to the SBS IC frame was received on the primary 20 MHz channel or the AP determines that it has some other higher priority task to complete, among other factors.

In some embodiments, upon making such a decision to forgo the TXOP, the AP may not need to provide a notification of the same to the STAs addressed in the SBS IC frame. In some embodiments, if a DSO STA that was addressed in an SBS IC frame and that performed the sub-band switch does not receive any frame addressed to it within a specific threshold duration, the DSO STA may switch back to the primary channel. In certain embodiments, if the DSO STA observes a preamble with the BSS color matching that of its own AP, but with a different destination address, and if the AP has indicated that the DSO STA may be served later within the TXOP, the DSO STA may wait for a longer threshold duration before switching back to the primary channel.

In some embodiments, upon making such a decision to forgo the TXOP, the AP may transmit a frame indicating the end of the TXOP. In certain embodiments, the frame may be transmitted in a non-HT duplicate PPDU format. In some embodiments, the frame can be a CF-end frame. In certain embodiments, the frame can be a new frame such as a new action frame. In some embodiments, the frame may also carry an indication of a subset of DSO STAs which may not be served within the TXOP and which may switch back to the primary channel.

Enabling joint operation in EMLSR/EMLMR mode and DSO mode in accordance with this disclosure is described herein. In some embodiments, a device may not operatin in EMLSR/EMLMR modes and DSO modes simultaneously. In some embodiments, a device may be capable of operating in EMLSR/EMLMR mode and in DSO mode simultaneously. In certain embodiments, such a device may declare, in its UHR Capabilities element, two padding delays, including one for DSO channel switch and one for the EMLSR/EMLMR link switch delay. In some embodiments, the device may report a single value that is applicable to all of the switches.

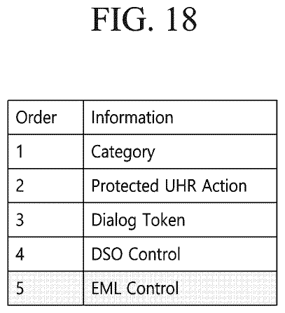

FIG. 18 illustrates an EML Control field as an optional subfield of the DSO Notification frame in accordance with an embodiment. In some embodiments, to simultaneously switch to DSO mode and EMLSR mode or DSO mode and EMLMR mode, the EML Control field can be an optional sub-field of the DSO Notification frame, as shown in FIG. 18 in accordance with an embodiment. The presence of this EML Control field in the DSO Notification frame can be indicated in an “EML Control Included” bit in the DSO Control field. In some embodiments, the DSO Notification frame and EML mode frame can be sent separately to switch into EMLSR/EMLMR mode and DSO modes, respectively. In some embodiments, the DSO Links can be the same as EMLSR/EMLMR links. In certain embodiments, the Link Bitmaps can be indicated separately for DSO and EMLSR/EMLMR operation.

In some embodiments, if the DSO padding delay and EMLSR/EMLMR padding delay are different values, the AP can apply the larger of the two delays when recommending the non-AP STA operating on an EMLSR/EMLMR link and also a DSO link to switch to a non-primary channel. If the link is an EMLSR/EMLMR link and not a DSO link, then the EMLSR/EMLMR padding delay may be applicable. If the link is a DSO link but not an EMLSR/EMLMR link, then the DSO padding delay may be applicable to switch to another subchannel.

In some embodiments, any rules applicable to EMLSR/EMLMR operation, like group addressed frame buffering, non-transmission of ICF on other links while there is an ongoing frame exchange on a first link with EMLSR or during a restricted target-wake-time (rTWT) service period (SP) on a first link, among others, can be applicable when the device operates jointly in DSO mode and EMLSR/EMLMR mode. In some embodiments, the capability to use of BSRP as an SBS IC frame may be implicitly applicable to these types of devices. In some embodiments, the capability can be explicitly indicated as shown in FIG. 17A and FIG. 17B.

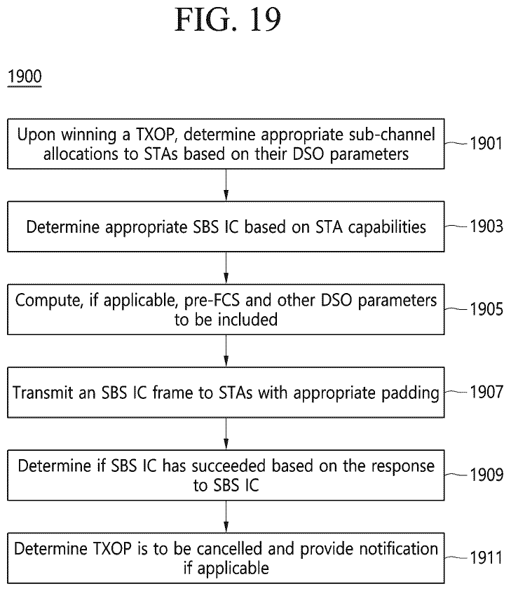

FIG. 19 illustrates a flow chart of an example process performed by an AP for transmitting a SBS IC frame to initiate a sub-band switch operation of DSO devices. Although one or more operations are described or shown in particular sequential order, in other embodiments the operations may be rearranged in a different order, which may include performance of multiple operations in at least partially overlapping time periods. The flowchart depicted in FIG. 19 illustrates operations performed in an AP, such as the AP illustrated in FIG. 3.

In operation 1901, the AP, upon winning a TXOP, determines appropriate sub-channel allocations to the STAs based on their DSO parameters. In some embodiments, the AP may transmit a CTS-to-Self frame in a non-HT duplicate PPDU format to protect all sub-channels where it has won the channel access.

In operation 1903, the AP determines the appropriate SBS IC based on the STA capabilities. In some embodiments, an MU-RTS frame or BSRP frame may be used as the SBS IC frame for DSO devices. In some embodiments, a Common Info field can have a DSO included field or a sub-type field to indicate that the MU-RTS or BSRP frame is an SBS IC frame. In some embodiments, the reserved field of the User Info field may be used for indicating DSO parameters in the DSO-specific user info field.

In operation 1905, the AP computes, if applicable, pre-FCS and other DSO parameters to be included. In some embodiments, a parameter can be a scheduling time field to indicate whether the AP intends to perform frame exchanges with the indicated STAs immediately or later within the TXOP, respectively. In some embodiments, the AP can include a pre-FCS field in the User Info List of the MU-RTS or BSRP frame that can be used by DSO devices for performing frame check. Since the User Info List comes before padding, the DSO devices can perform the frame check using the pre-FCS check field and then perform the sub-band switch during the padding.

In operation 1907, the AP transmits an SBS IC frame to the STAs with appropriate padding. In some embodiments, a medium-reserving transmission on the medium can be the padding field of the MU-RTS or BSRP frame.

In operation 1909, the AP determines if the SBS IC frame has succeeded based on the response to the SBS IC frame. In some embodiments, if no response is received to an SBS IC frame on the primary 20 MHz subchannel, the SBS IC frame transmission may be considered as having failed. In some embodiments, if a successful response is received on any 20 MHz subchannel of the TXOP bandwidth, the SBS IC frame may be considered as being successful. In some embodiments, if no response was received on the primary 20 MHz channel, the AP may transmit padding bits on the primary 20 MHz channel for the duration of the downlink frame transmissions that it performs on the other 20 MHz sub-bands where a response was received successfully

In operation 1911, the AP determines that the TXOP is to be cancelled and provides a notification if applicable. In some embodiments, upon making such a decision to forgo the TXOP, the AP may not provide a notification of the same to the STAs addressed in the SBS IC. In some embodiments, upon making such a decision to forgo the TXOP, the AP may transmit a frame indicating the end of the TXOP. In some embodiments, the frame may be transmitted in a non-HT duplicate PPDU format. For example, this frame can be a CF-end frame. In some embodiments, the frame can be a new frame, such as a new action frame. In some embodiments, the frame may also carry an indication of a subset of DSO STAs which may not be served within the TXOP and which may switch back to the primary channel.

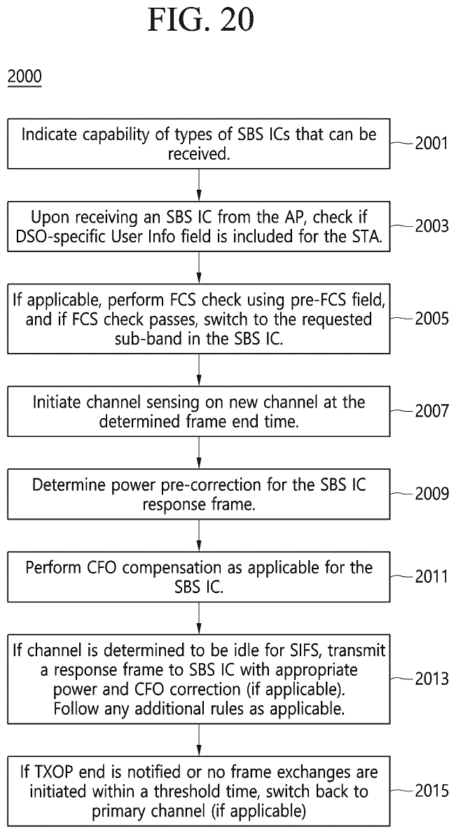

FIG. 20 illustrates a flow chart of an example process performed by a non-AP STA upon receiving an SBS IC frame and for the transmission of the corresponding response in accordance with an embodiment. Although one or more operations are described or shown in particular sequential order, in other embodiments the operations may be rearranged in a different order, which may include performance of multiple operations in at least partially overlapping time periods. The flowchart depicted in FIG. 20 illustrates operations performed in a non-AP STA, such as the non-AP STA illustrated in FIG. 3.

In operation 2001, the STA provides a capability indication of types of SBS ICs that can be received.

In operation 2003, the STA, upon receiving an SBS IC from the AP, checks if the DSO-specific User Info field is included for the STA. In some embodiments, an trigger frame may be used as the SBS IC frame for DSO devices. In some embodiments, a Common Info field can have a DSO Included field or a sub-type field to indicate that the trigger frame is an SBS IC frame. In some embodiments, the reserved field of the User Info field may be used for indicating DSO parameters in the DSO-specific User Info field.

In operation 2005, the STA performs, if appliable FCS check using pre-FCS field, and if the FCS check passes, switches to the requested sub-band in the SBS IC. In some embodiments, the AP can include a pre-FCS field in the User Info List of the trigger frame that can be used by STA for performing frame check. Since the User Info list comes before padding, the STA can perform the frame check using the pre-FCS check field and then perform the sub-band switch during the padding.

In operation 2007, the STA initiates channel sensing on new channel at the determined frame end time.

In operation 2009, the STA determines power pre-correction for the SBS IC response frame. In some embodiments, to help DSO STA determine the TX power, the UL Target Receive Power subfield of the SBS IC frame may be set to 127, to enable the STA to use its maximum allowed transmit power. In some embodiments, a mapping function may be proposed to map the measured pathloss on the primary 20 MHz channel by a DSO STA to the pathloss expected by the DSO STA on the new sub-band after the sub-band switch. In some embodiments, the STA, after subband switching, may acquire the DL received signal power measurement using the remaining portion of the SBS IC frame, such as the remaining OFDM symbols. In order to do so, the STA may indicate a DSO Padding Delay value that is long enough for it to be able to receive the necessary OFDM symbols of the SBS IC frame after performing the DSO sub-band switch. In certain embodiments, a known signal of a given power level may be transmitted during at least a portion of the remaining frame, e.g., at a predetermined OFDM symbol location. The STA then may use this known signal to acquire or refine the received signal power measurement on the assigned sub-band and may use this value to then determine the transmit power for the response

In operation 2011, the STA performs CFO compensation as applicable for the SBS IC. In some embodiment, to estimate the CFO value after performing the sub-band switch, the STA may use some of the received OFDM symbols of the SBS IC frame after performing the sub-band switch. In order to do so, the STA may indicate a DSO Padding Delay value that is long enough for it to be able to receive the necessary OFDM symbols of the SBS IC frame after performing the DSO sub-band switch

In operation 2013, the STA transmits, if the channel is determined to be idle for SIFS, a response frame to the SBS IC frame with appropriate power and CFO correction if applicable and follows any additional rules if applicable.

In operation 2015, the STA, if the TXOP end is notified or no frame exchanges are initiated within a threshold time, switches back to the primary channel, if applicable.

Determining SBS compliance before data transmission in accordance with this disclosure is described herein. In some embodiments, it may be optional for DSO STAs to comply with the AP's request to perform a sub-band switch within a TXOP. Correspondingly, in beginning of TXOP, an AP may intend to identify which STAs are willing to comply with the sub-band switch request. To do so, the AP may transmit a trigger frame to all the STAs it intends to serve within the TXOP. This trigger frame can be, for example, a variant of the Buffer Status Report Poll (BSRP) frame, a variant of the multi-user request to send (MU-RTS) frame or a new variant of a trigger frame. By using the response to this trigger frame, a SIFS duration after the trigger frame, a STA can indicate whether it will comply with the AP's request to perform the sub-band switch within the TXOP. In some embodiments, if the trigger frame is a BSRP frame, a new format for the User Info field may be defined that may be applicable for STAs operating in DSO mode. Similarly, in certain embodiments, the response to the BSRP trigger frame may be different if transmitted by a STA operating in DSO mode. In addition to (or instead of) carrying the buffer status report information, the response may carry an explicit indication of whether the DSO STA is willing to comply with the sub-band switch request.

In some embodiments, to ensure that the TXOP bandwidth is protected during the trigger response, the AP may try to ensure that the response frames from the STAs jointly occupy the full TXOP bandwidth with high probability. To do so, in the trigger frame the AP may assign different RUs across the TXOP bandwidth to the different STAs for sending the trigger response, as indicated in the RU Allocation field of the User Info fields corresponding to those STAs. If a STA is operating in DSO mode, its RU allocation can be outside of its current operating bandwidth and, correspondingly, the STA may be expected to perform a sub-band switch operation before sending the trigger response frame (if it decides to comply with the AP's request). The AP may ensure that sufficient padding is provided in the trigger frame to ensure all such STAs which are required to perform a sub-band switch before sending the trigger response, are able to do so before the end of the trigger frame. In some embodiments, the RUs allocated to DSO STAs in the trigger frame for the response may be distributed RUs, i.e., the subcarriers assigned to a STA may have large inter-subcarrier frequency spacings. This can be to ensure that the full TXOP bandwidth remains protected despite some STAs not responding to the trigger frame.

In some embodiments, the trigger response may be expected to be transmitted below a certain MCS or rate and in a specific frame format. There may also be mechanisms to determine the applicable transmit power for the response frame. In some embodiments, the CFO requirements on the trigger response may be lowered. In certain embodiments, aggregation of data in the response may be prohibited and/or the duration of the trigger response may be constrained. The AP may indicate the duration of the trigger response in the Common Info field of the trigger frame and a responding STA may use padding to ensure that the response occupies the medium till the expected duration of the trigger response.

In some embodiments, the actual RUs assigned for data transmissions (for downlink or triggered uplink) among others, later in the TXOP to a STA in DSO mode can be different from the RUs assigned to it for sending the trigger response frame. In some embodiments, there may be a pre-determined mapping between RU allocated to a DSO STA for the trigger response and the sub-band that the DSO STA is expected to monitor for data transmissions among other operations. Accordingly, based on the RU allocation field of the trigger frame which indicates the RU for the trigger response, the DSO STA can determine the subband it is supposed to monitor for data transmission/reception etc. For example, each allocated RU for trigger response may be associated with a specific 20/40/80/160 MHz channels that it is a part of. Correspondingly a DSO STA with X MHz operating bandwidth may be expected to monitor the X MHz channel that the RU assigned to it for the trigger response is a part of. In certain embodiments, there may be an explicit and separate indication of the sub-band that the DSO STA is expected to monitor, and where they may be assigned RUs for data transmissions later in the TXOP. This indication can be carried in a Sub-band Allocation subfield of the User Info field addressed to the DSO STA in the trigger frame sent by the AP. In some embodiments, the Subband Allocation may be a superset of the RU Allocation assigned to the DSO STA for the trigger response, unless there are exceptions as described hererin. In some embodiments, the explicit indication may be optional, i.e., Subband Allocation field may be optionally present in the User Info field as indicated by a Subband Allocation Present bit in the User Info field. If the Subband Allocation field is not present in the User Info field for a DSO STA, then the STA may determine its sub-band for monitoring based on the pre-determined mapping. If the Sub-band Allocation subfield is present in the User Info field for a DSO STA, then the device may use this field to determine the sub-band to monitor. In some embodiments, the AP may indicate the maximum size of the resource unit it intends to allocate to a DSO STA for the data transmissions. When receiving this indication in a User Info field addressed to a DSO STA, the DSO STA may determine the sub-band for monitoring based on this indication and the pre-determined mapping between RU Allocation and monitoring bandwidth.

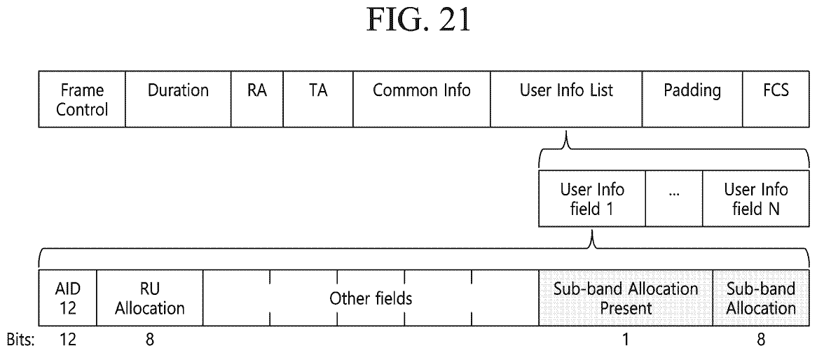

FIG. 21 illustrates a User Info field of the SBS IC providing separate indication of trigger response RU and the sub-band to monitor for transmissions in accordance with an embodiment. For example, in the case of the BSRP frame, the Subband Allocation field may borrow the same field bits as the legacy SS Allocation/RA-RU Information field.

In some embodiments, based on the trigger responses received from the triggered STAs, the AP may know which STAs are capable of reception within the TXOP on the different sub-bands of the TXOP. Thus, it may perform an informed allocation of the RUs for data transmissions etc. within the TXOP.

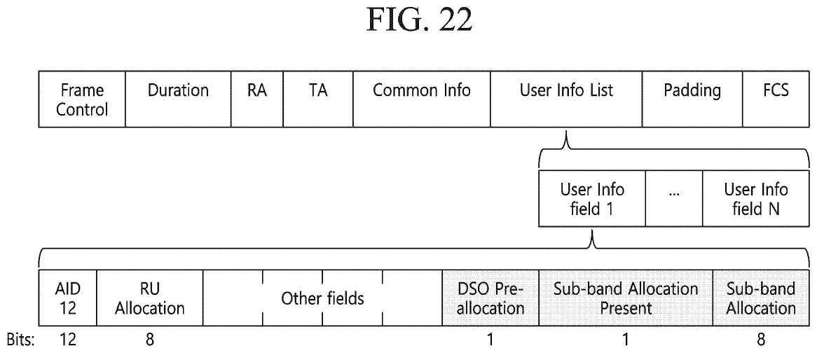

FIG. 22 illustrates a User Info field of the SBS IC frame providing an indication of sub-band pre-allocation to indicate the need for a deferred sub-band switch after sending the trigger response in accordance with an embodiment. In some embodiments, the AP may determine some DSO devices may need a long time to switch to a new sub-band and/or may not be capable of meeting the transmit power or carrier frequency offset requirements associated with the trigger response frame if the devices are required to transmit the response after a sub-band switch. In some embodiments, for such DSO devices, the AP may provide the RU allocation for the trigger response within their current operating bandwidth itself and may carry a separate indication of the sub-band they are expected to monitor for the rest of the TXOP for data transmissions, etc. The indication of the sub-band can be carried in a Sub-band Allocation subfield of the User Info field addressed to those DSO STAs of the trigger frame transmitted by the AP. In some embodiments, the allocated sub-band by the Sub-band Allocation subfield can be outside of the RU allocated to the STA for the trigger response in the RU Allocation field. If the RU allocated to a DSO STA for trigger response is within its current operating bandwidth and the allocated sub-band for monitoring is not a subset of its current operating bandwidth, then the DSO STA may be expected to perform the sub-band switch after transmitting the response to the trigger frame. In some embodiments, it may be implied that the AP may not serve the DSO STA immediately after receiving the trigger response frame. In certain embodiments, the operation may be similar, but there can be a separate bit in the User Info field addressed to a DSO STA of the trigger frame transmitted by the AP to explicitly indicate to the STA that it is expected to respond to the trigger frame and then perform the Sub-band switch and that the AP will not serve the STA immediately after the trigger response. This bit can be called, for example, the DSO Preallocation field or DSO Delayed Allocation field. In some embodiments, such DSO devices may not be required to send a response to the trigger frame and the AP may not serve the DSO STAs immediately within the TXOP. The AP may provide the indication that a DSO STA is not required to respond to the trigger frame using the DSO Preallocation subfield of the User Info field addressed to the STA of the trigger frame. The AP may indicate the sub-band that the DSO STA is expected to monitor using the RU Allocation subfield of the User Info field addressed to the STA of the trigger frame.

Embodiments in accordance with this disclosure may use existing trigger frames for DSO operation, including providing mechanisms for DSO devices to perform FCS check on SBS IC frames before the padding field of the SBS IC frame begins. Accordingly, embodiments in accordance with this disclosure provide mechanisms that enable DSO devices to check for the correctness of the SBS IC frame (via the frame check sequence) before they perform the sub-band switch operation. Embodiments in accordance with this disclosure provide mechanisms that allow an EMLSR device to also operate in DSO mode.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to:
generate a trigger frame that solicits a response from one or more stations (STAs), wherein the trigger frame includes a pre frame check sequence (pre-FCS) field, a padding field, and a frame check sequence (FCS) field, the pre-FCS field preceding the padding field;
transmit, to the one or more STAs, the trigger frame to request the one or more STAs to perform a dynamic sub-band switch operation; and
determine whether the dynamic sub-band switch operation is successfully performed at the one or more STAs based on whether or not a response is received from the one or more STAs in response to the trigger frame.

2. The AP of claim 1, wherein the dynamic sub-band switch operation is a channel switch or a bandwidth switch operation, wherein the trigger frame is transmitted to one or more STAS operating in dynamic sub-band operation, enhanced multi-link single radio operation or dynamic power save operation modes.

3. The AP of claim 1, wherein a value of the pre-FCS field is computed based on bits preceding a location of the pre-FCS field in the trigger frame.

4. The AP of claim 1, wherein the trigger frame includes a user info list field including one or more user info fields and a location of the pre-FCS field in the trigger frame is determined based on the location of the user info fields addressed to the STAs that are expected to perform the dynamic sub-band switch operation, user info fields addressed to other STAs, and a start of the padding field.

5. The AP of claim 1, wherein the trigger frame includes a user info list field that includes one or more user info fields, wherein bits of a pre-FCS value are carried across one or more adjacent user info fields with predetermined values for an association identifier (AID) subfields.

6. The AP of claim 1, wherein the trigger frame includes a pre-FCS location field that indicates a location of the pre-FCS field within the trigger frame.

7. The AP of claim 1, wherein the trigger frame is a multi-user request-to-send (MU-RTS) frame, wherein the processor is further configured to transmit a padding field of the MU-RTS frame on a wireless medium to protect the wireless medium during the dynamic sub-band switch operation.

8. The AP of claim 1, wherein the pre-FCS field includes a pre-FCS termination field that includes a pre-determined bit sequence which indicates a start of the padding field.

9. A station (STA) in a wireless network, comprising:
a memory; and
a processor coupled to the memory, the processor configured to:
receive, from an access point (AP), a trigger frame that includes a pre frame check sequence (pre-FCS) field, a padding field, and a frame check sequence (FCS) field, the pre-FCS field preceding the padding field; and
transmit, to the AP, a response frame in response to the trigger frame.

10. The STA of claim 9, wherein the processor is further configured to determine a presence of the pre-FCS field based on a presence or location indication of the pre-FCS field carried in the trigger frame.

11. The STA of claim 9, where the processor is further configured to perform a validity check of the pre-FCS field of the trigger frame.

12. The STA of claim 11, wherein the validity check of the pre-FCS field includes computing an FCS value using a received bits of the trigger frame that precede the pre-FCS field, and comparing the computed FCS value to the pre-FCS field.

13. The STA of claim 11, wherein the processor is further configured to:
receive an indication in the trigger frame that requests the STA perform a dynamic sub-band switch operation; and
determine whether to comply with the request in the trigger frame based on the result of the validity check of the pre-FCS field.

14. The STA of claim 11, wherein the processor is further configured to, based on the result of the validity check of the pre-FCS field, perform an early termination of the reception of the trigger frame.

15. A computer-implemented method for wireless communication by an access point (AP) in a wireless network, comprising:
generating a trigger frame that solicits a response from one or more stations (STAs), wherein the trigger frame includes a pre frame check sequence (pre-FCS) field, a padding field, and a frame check sequence (FCS) field, the pre-FCS field preceding the padding field;
transmitting, to the one or more STAs, the trigger frame to request the one or more STAs to perform a dynamic sub-band switch operation; and
determining whether the dynamic sub-band switch operation is successfully performed at the one or more STAs based on whether or not a response is received from the one or more STAs in response to the trigger frame.

16. The computer-implemented method of claim 15, wherein the dynamic sub-band switch operation is a channel switch or a bandwidth switch operation, wherein the trigger frame is transmitted to one or more STAs operating in dynamic sub-band operation, enhanced multi-link single radio operation or dynamic power save operation modes.

17. The computer-implemented method of claim 15, wherein a value of the pre-FCS field is computed based on bits preceding a location of the pre-FCS field in the trigger frame.

18. The computer-implemented method of claim 15, wherein the trigger frame includes a user info list field including one or more user info fields and a location of the pre-FCS field in the trigger frame is determined based on a location of the user info fields addressed to the STAs that are expected to perform the dynamic sub-band switch operation, user info fields addressed to other STAs, and a start of the padding field.

19. The computer-implemented method of claim 15, wherein the trigger frame includes a user info list field that includes one or more user info fields, wherein bits of a pre-FCS value are carried across one or more adjacent user info fields with predetermined values for an association identifier (AID) subfields.

20. The computer-implemented method of claim 15, wherein the trigger frame includes a pre-FCS location field that indicates a location of the pre-FCS field within the trigger frame.
